(19) United States
(12) Patent Application Publication
(10) Pub. No.: US 2026/0342620 A1
(43) Pub. Date: Oct. 29, 2026

(54) OPTIMIZATION OF CHANNEL INFORMATION SIGNALING IN FRONTHAUL INTERFACE

(71) Applicant: QUALCOMM Incorporated, San Diego, CA (US)

(72) Inventors: Akashnil ROY, Kolkata (IN); Aman Kumar SINGH, Hyderabad (IN)

(21) Appl. No.: 19/189,441

(22) Filed: Apr. 25, 2025

(51) Int. Cl. H04L 25/02

(52) U.S. Cl. CPC H04L 25/0228; H04L 25/0204

(57) ABSTRACT

Aspects relate to a wireless communication system for wireless communication. The wireless communication system may include an Open-Radio Access Network (O-RAN) Distributed Unit (O-DU) that receives a sounding reference signal (SRS) associated with a user equipment. The O-DU generates, based on the SRS, a control plane (C-plane) message. The C-plane message indicates a first set of channel estimates for a set of active antennas of a plurality of antennas associated with an O-RAN Radio Unit (O-RU). The C-plane message does not include channel estimates for a set of inactive antennas of the plurality of antennas. The O-DU transmits the C-plane message to the O-RU.

### BACKGROUND

### Field of the Disclosure

The present disclosure relates generally to wireless communication systems, and, more particularly, to channel information signaling in fronthaul interface.

### Description of Related Art

Wireless communication systems are widely deployed to provide a range of communication services such as telephony, data transmission, messaging, multimedia streaming, broadcasting, or the like. The wireless communication systems may enable communication between multiple users by employing various multiple-access technologies, for example, Code Division Multiple Access (CDMA), Time Division Multiple Access (TDMA), Frequency Division Multiple Access (FDMA), Orthogonal Frequency Division Multiple Access (OFDMA), or the like. Examples of wireless multiple-access communication systems may include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems. A wireless multiple-access communication system may include one or more base stations that facilitate wireless communication for communication devices such as User Equipment (UE).

In the context of an Open Radio Access Network (O-RAN) architecture, functions of a base station or a network node may be disaggregated across network entities. For example, an O-RAN network node may include an O-RAN Radio Unit (O-RU) and an O-RAN Distributed Unit (O-DU). The O-RU may handle wireless communications with devices, such as UEs, whereas the O-DU may support the wireless communications performed by the O-RU. The disaggregation of O-RAN network node functionality may enable flexibility and scalability.

### SUMMARY

The systems, methods, and devices of this disclosure each have several innovative aspects, no single one of which is solely responsible for the desirable attributes disclosed herein. In some cases, due to disaggregation of Open Radio Access Network (O-RAN) network node functionality, an O-RAN Distributed Unit (O-DU) and an O-RAN Radio Unit (O-RU) may exchange information for seamless operation. One such interaction may involve the O-DU transmitting configuration details to the O-RU to control the performance of one or more transceiving elements, such as antennas, associated with the O-RU. Some of these antennas may be switched off (e.g., inactive) while some antennas may remain active based on operational settings; however, the O-DU transmits the configuration details for the antennas, regardless of whether the antennas are active or inactive. Accordingly, redundant information related to inactive antennas is transmitted over a fronthaul interface between the O-DU and the O-RU.

To reduce fronthaul traffic between the O-DU and the O-RU, the O-DU may be configured to transmit channel estimates for active antennas to the O-RU, while suppressing channel estimate transmission for inactive antennas. Thus, the overhead in the fronthaul interface may be reduced, which in turn can enable to improve network performance, such as network latency, network bandwidth, or the like.

The following is a summary of some non-limiting aspects of the disclosure:

A wireless communication method in an O-DU is described. The method may include receiving a first sounding reference signal (SRS) associated with a User Equipment (UE), generating, based on the first SRS, a first control plane (C-plane) message, and transmitting the first C-plane message to an O-RU. The first C-plane message may indicate a first set of channel estimates for a set of active antennas of a plurality of antennas associated with the O-RU. The first C-plane message may not include channel estimates for a set of inactive antennas of the plurality of antennas.

An O-DU for wireless communication is described. The O-DU may include one or more memories and one or more processors coupled to the one or more memories. The one or more processors may be individually or collectively configured to cause the O-DU to receive a first SRS associated with a UE, generate based on the first SRS, a first C-plane message, and transmit the first C-plane message to an O-RU. The first C-plane message may indicate a first set of channel estimates for a set of active antennas of a plurality of antennas associated with the O-RU. The first C-plane message may not include channel estimates for a set of inactive antennas of the plurality of antennas.

Another O-DU for wireless communication is described. The O-DU may include a means for receiving a first SRS associated with a UE, a means for generating, based on the first SRS, a first C-plane message, and a means for transmitting the first C-plane message to an O-RU. The first C-plane message may indicate a first set of channel estimates for a set of active antennas of a plurality of antennas associated with the O-RU. The first C-plane message may not include channel estimates for a set of inactive antennas of the plurality of antennas.

A non-transitory computer-readable medium storing code for wireless communications is described. The code may include instructions executable by one or more processors to receive a first SRS associated with a UE, generate based on the first SRS, a first C-plane message, and transmit the first C-plane message to an O-RU. The first C-plane message may indicate a first set of channel estimates for a set of active antennas of a plurality of antennas associated with the O-RU. The first C-plane message may not include channel estimates for a set of inactive antennas of the plurality of antennas.

A wireless communication method in an O-RU is described. The method may include transmitting, to an O-DU, a first SRS associated with a UE and receiving, from the O-DU, a first C-plane message in response to the transmission of the first SRS. The first C-plane message may indicate a first set of channel estimates for a set of active antennas of a plurality of antennas associated with the O-RU. The first C-plane message may not include channel estimates for a set of inactive antennas of the plurality of antennas.

An O-RU for wireless communication is described. The O-RU may include one or more memories and one or more processors coupled to the one or more memories. The one or more processors may be individually or collectively configured to cause the O-RU to transmit, to an O-DU, a first SRS associated with a UE and receive, from the O-DU, a first C-plane message in response to the transmission of the first SRS. The first C-plane message may indicate a first set of channel estimates for a set of active antennas of a plurality of antennas associated with the O-RU. The first C-plane message may not include channel estimates for a set of inactive antennas of the plurality of antennas.

Another O-RU for wireless communication is described. The O-RU may include a means for transmitting, to an O-DU, a first SRS associated with a UE and a means for receiving, from the O-DU, a first C-plane message in response to the transmission of the first SRS. The first C-plane message may indicate a first set of channel estimates for a set of active antennas of a plurality of antennas associated with the O-RU. The first C-plane message may not include channel estimates for a set of inactive antennas of the plurality of antennas.

A non-transitory computer-readable medium storing code for wireless communications is described. The code may include instructions executable by one or more processors to transmit, to an O-DU, a first SRS associated with a UE and receive, from the O-DU, a first C-plane message in response to the transmission of the first SRS. The first C-plane message may indicate a first set of channel estimates for a set of active antennas of a plurality of antennas associated with the O-RU. The first C-plane message may not include channel estimates for a set of inactive antennas of the plurality of antennas.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of a wireless communication system, in accordance with certain aspects of the present disclosure;

FIG. 2 is a diagram that illustrates an example of an Open Radio Access Network (O-RAN) architecture, in accordance with certain aspects of the present disclosure;

FIG. 3 is a diagram that illustrates an example of a message flow between an O-RAN Distributed Unit (O-DU) and an O-RAN Radio Unit (O-RU), in accordance with certain aspects of the present disclosure;

FIG. 4 is a diagram that illustrates an example of a message flow between an O-DU and an O-RU, in accordance with certain aspects of the present disclosure;

FIG. 5 is a diagram that illustrates an example of a first control plane (C-plane) message, in accordance with certain aspects of the present disclosure;

FIG. 6 is a diagram that illustrates an example of a first C-plane message, in accordance with certain aspects of the present disclosure;

FIG. 7 is a diagram that illustrates a high-level flowchart of a process (e.g., a method) for wireless communication, in accordance with certain aspects of the present disclosure;

FIG. 8 is a diagram that illustrates a flowchart of a process (e.g., a method) for wireless communication, in accordance with certain aspects of the present disclosure;

FIG. 9 is a diagram that illustrates a flowchart of a process (e.g., a method) for wireless communication, in accordance with certain aspects of the present disclosure;

FIGS. 10A and 10B, collectively, illustrate a flowchart of a process (e.g., a method) for wireless communication, in accordance with certain aspects of the present disclosure;

FIG. 11 is a diagram that illustrates an example of an O-DU, in accordance with certain aspects of the present disclosure; and

FIG. 12 is a diagram that illustrates an example of an O-RU, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A communication system may include a radio access network (RAN) that supports wireless communication. Communication of a RAN may be performed in accordance with one or more radio access technologies (RATs), including fourth-generation (4G), fifth-generation (5G), or sixth-generation (6G), or the like, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, for example, machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, artificial intelligence or machine learning (AI/ML), or the like.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some examples, an Open RAN (O-RAN) architecture may enable the functions of a base station to be disaggregated across multiple network entities or nodes. For example, a RAN node within the O-RAN architecture may include an O-RAN Radio Unit (O-RU), an O-RAN Distributed Unit (O-DU), or a combination thereof. The O-RU may handle wireless communications with communication devices, such as User Equipment (UE), while the O-DU may support the wireless communications performed by the O-RU. While the disaggregation of base station functionalities allows for flexibility and scalability, the disaggregation of base station functionalities may involve an exchange of information between the O-DU and the O-RU.

One such interaction between the O-DU and O-RU may involve the O-DU transmitting a control plane (C-plane) message to the O-RU to control the performance of antennas associated with the O-RU. For example, the O-DU may instruct the O-RU to disable certain antennas to conserve energy when these antennas are not in use for active communication. Additionally, the O-DU may transmit a different C-plane message to adapt the antennas to varying communication requirements. For example, the O-DU may communicate configuration details (e.g., channel estimates) for the antennas to enhance signal focus and coverage.

In many scenarios, the O-DU transmits the channel estimates without accounting for the operational status of the antennas. For example, the channel estimates are transmitted indiscriminately for all antennas, regardless of whether the antennas are enabled (e.g., active) or disabled (e.g., inactive). Accordingly, redundant information related to disabled (or inactive) antennas may be transmitted over a fronthaul interface between the O-DU and O-RU. In an example, the fronthaul interface may refer to a communication interface that connects the O-DU and the O-RU. The transmission of redundant information consumes additional bandwidth and increases communication overhead in the fronthaul interface. Further, the transmission of redundant information can increase processing requirements on both the O-DU and the O-RU, which in turn can lead to higher latency, reduced resource availability, and impact overall network performance.

Certain aspects disclosed herein provide systems and methods for optimization of channel information signaling in the fronthaul interface. In an example, the O-DU may receive a sounding reference signal (SRS) associated with a UE. Further, the O-DU may generate a first C-plane message based on the received SRS. The first C-plane message may indicate a first set of channel estimates for a set of active antennas of a plurality of antennas. The plurality of antennas may be associated with the O-RU. The first C-plane message may not include channel estimates for a set of inactive antennas of the plurality of antennas. In an example, an active antenna of the set of active antennas may correspond to (or include) a first antenna of the plurality of antennas that is to be activated (or that shall remain active, turned ON). Further, an inactive antenna of the set of inactive antennas may correspond to a second antenna of the plurality of antennas that is to be deactivated (or that shall remain inactive, turned OFF). The second antenna may be different from the first antenna within the plurality of antennas. The O-DU may further transmit the first C-plane message to the O-RU. As a result, the channel estimates of the set of inactive antennas may not be relayed to the O-RU via the fronthaul interface. Thus, the overhead in the fronthaul interface may be reduced, which in turn can enable to improve network performance, such as network latency, network bandwidth, or the like.

In some aspects, each channel estimate of the first set of channel estimates is associated with an antenna identifier of a corresponding active antenna of the set of active antennas, in the first C-plane message. After the transmission of the first C-plane message, the O-DU may further receive a second SRS associated with the UE. Further, the O-DU may determine a second set of channel estimates for the set of active antennas based on the second SRS. Additionally, the O-DU may generate a second C-plane message that indicates one or more channel estimates of the determined second set of channel estimates. The one or more channel estimates of the determined second set of channel estimates indicated in the second C-plane message deviate from corresponding one or more channel estimates of the first set of channel estimates. Thus, the one or more channel estimates of the determined second set of channel estimates indicated in the second C-plane message are different from the corresponding one or more channel estimates of the first set of channel estimates. Further, the second C-plane message may not include one or more channel estimates of the second set of channel estimates that are same as corresponding one or more channel estimates of the first set of channel estimates. The O-DU may further transmit the second C-plane message to the O-RU. Thus, the one or more channel estimates of the second set of channel estimates that are same as the corresponding one or more channel estimates of the first set of channel estimates may not be communicated to the O-RU via the fronthaul interface. Thus, the overhead in the fronthaul interface may be further reduced during transmission subsequent C-plane messages from the O-DU to the O-RU.

In further aspects, the O-DU may transmit a third C-plane message associated with the plurality of antennas to the O-RU. The third C-plane message may be transmitted prior to the transmission of the first C-plane message. The third C-plane message may indicate the set of active antennas and the set of inactive antennas. Further, the third C-plane message may include a bitmap having a plurality of bits, where each bit of the plurality of bits is mapped to a corresponding antenna of the plurality of antennas. Additionally, each bit of the plurality of bits has one of a first value indicating that the corresponding antenna is active, or a second value indicating that the corresponding antenna is inactive. In the first C-plane message, the first set of channel estimates for the set of active antennas may be indicated in a same sequence in which the set of active antennas is indicated in the bitmap of the third C-plane message. Since the first set of channel estimates in the first C-plane message is indicated in the same sequence in which the set of active antennas are indicated in the third C-plane message, the O-RU may be enabled to not perform additional processes, such as performing a mapping between the first set of channel estimates and the set of active antennas, determining which channel estimate among the first set of channel estimates corresponds to an antenna of the plurality of antennas, or the like. Accordingly, the demand for the computation resources of the O-RU may be reduced.

The terms “O-RAN Radio Unit” (O-RU) and “O-RAN Distributed Unit” (O-DU) are used herein for illustrative and descriptive purposes to reference functional components within a wireless communication network. These terms are not intended to limit the scope of the disclosure to any specific terminology or technology. It will be apparent to a person skilled in the art that as technology evolves, these network nodes may be referred to by different names or have different functional groupings. Therefore, the terms O-RU and O-DU can encompass equivalent structures, devices, or functional units regardless of the terminology used in future technologies or implementations.

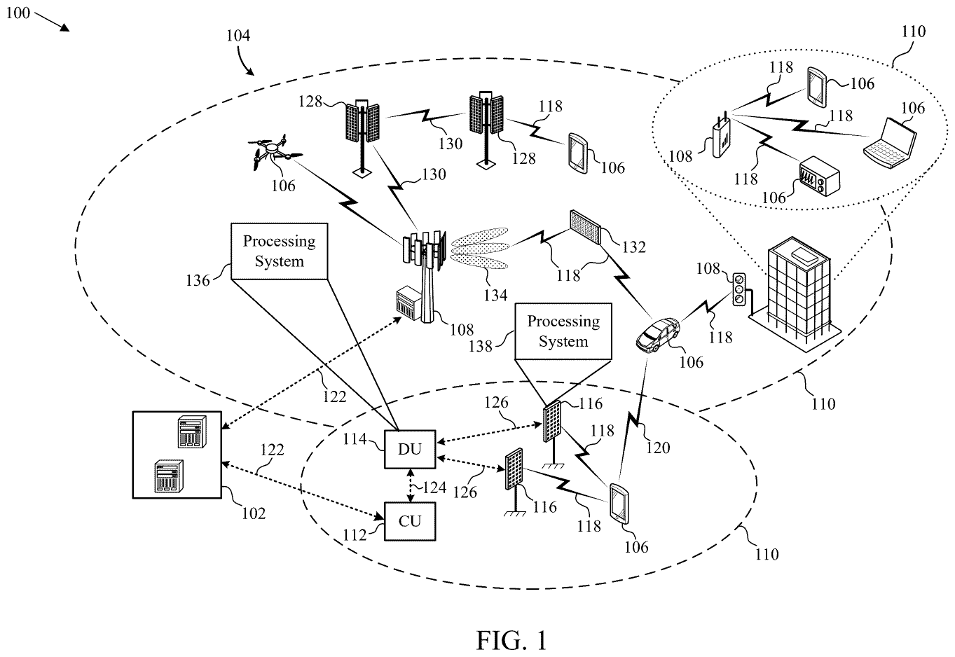

FIG. 1 is a diagram that illustrates an example of a wireless communication system 100, in accordance with certain aspects of the present disclosure. The wireless communication system 100 may include a core network 102 and a Radio Access Network (RAN) 104 that support communication with one or more devices, such as User Equipment (UEs) 106. A RAN 104 may include one or more network entities (e.g., nodes) 108 configured to support wireless communication with the UEs 106.

The wireless communication system 100 may support communication among network entities 108 and UEs 106 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer may also implement error detection techniques, error correction techniques, or retransmissions. In a control plane, a Radio Resource Control (RRC) layer may provide establishment, configuration, and maintenance of an RRC connection between UEs 106 and a network entity 108 or a core network 102, supporting radio bearers for user plane data. A Physical (PHY) layer may map transport channels to physical channels.

A core network 102 may support user authentication, access authorization, tracking, IP connectivity, and other access, routing, or mobility functions (such as via network entities 108). A core network 102 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 108 may support wireless communication in accordance with one or more coverage areas 110, and may be referred to as a network element, a network node, a RAN node, or network equipment, among other nomenclature. One or more of the network entities 108 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 108 support communication for one or more coverage areas 110 using the same or different RATs.

In some examples, a network entity 108 may be implemented in an aggregated (such as monolithic, standalone) architecture, which may utilize a protocol stack that is physically or logically integrated within one network entity 108 (such as a single physical RAN node). In some other examples, a network entity 108 may be implemented in a disaggregated architecture, which may utilize a protocol stack that is physically or logically distributed among multiple network entities 108, including in an integrated access and backhaul (IAB) network, an open RAN (O-RAN), or a virtualized RAN (vRAN). In a disaggregated architecture, a network entity 108 may include or be referred to as one or more of a central unit (CU) (such as CU 112), a distributed unit (DU) (such as DU 114), a radio unit (RU) (such as RU 116), or a combination thereof. The wireless communication system 100 may also implement a service-based architecture that provides a modular framework in which control plane functionality and common data repositories may be delivered through a set of interconnected network functions (NFs) that may access services of other NFs.

UEs 106 may be located in a coverage area 110 of one or more network entities 108, and may include or be referred to as an access terminal, a mobile station, a client device, or a subscriber unit. A UE 106 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 108 and a UE 106 may be supported using one or more of a communication link 118 (such as a Uu interface), which may include downlink communication from a network entity 108 to a UE 106, uplink communication from a UE 106 to a network entity 108, or both. Direct wireless communication between UEs 106 may be supported using a communication link 120 (such as a device-to-device (D2D) communication link, a sidelink, a PC5 interface).

Communication between a network entity 108 and a core network 102 may be supported using a backhaul link 122 (such as an S1, N2, N3, NG, or other interface). In some implementations, communication between network entities 108 may be supported using a backhaul link 122 (such as an X2, Xn, or other interface) either directly (such as directly between network entities 108) or indirectly (such as via a core network 102). In some implementations (such as in a disaggregated architecture), communication between a CU 112 and a DU 114 may be supported using a midhaul link 124, and communication between a DU 114 and an RU 116 may be supported using a fronthaul link 126. A backhaul link 122, a midhaul link 124, a fronthaul link 126, or any combination thereof may be or include one or more wired links (such as an electrical link, an optical fiber link), one or more wireless links (such as a radio link, a wireless optical link), or combinations thereof. Wireless backhaul, midhaul, or fronthaul may be implemented via one or more IAB nodes 128, which may act as a relay using resources of an IAB donor network entity 108 (such as via a wireless link 130).

The wireless communication system 100 may include one or more of a relay 132 that may steer or reflect signals transmitted by other entities, which may support any of the described communication links. A relay 132 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 108 and UEs 106 each may include one or multiple antennas. Multiple antennas of such devices may be used to employ techniques such as transmit diversity, receive diversity, Multiple Input Multiple Output (MIMO) communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 108 or a UE 106.

Beamforming, such as directional transmission or directional reception, is a signal processing technique that may be used at a transmitting device or a receiving device (such as at a network entity 108, at a UE 106) to shape or steer a beam 134 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 104) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 118, for a communication link 120, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 108), including in response to network conditions (such as to allocate uplink and downlink BWPs in response to traffic conditions), device capability (such as allocating BWPs with a greater quantity of RBs to UEs 106 with relatively higher capabilities), or both. A UE 106 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 106 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 108, a UE 106) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 104) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 108 may indicate (such as schedule, allocate) communication resources for a UE 106 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 106 may monitor control regions for control information according to one or more search space sets, which may include a common search space set (such as for sending control information to one or more UEs 106), UE-specific search space sets (such as for sending control information to a UE 106), or a combination thereof. A physical broadcast channel (PBCH) may be used to broadcast parameters to UEs 106 to synchronize with a network entity 108 and establish communications (such as to establish a communication link 118).

Reference signals may be communicated to establish reference characteristics (such as a frequency reference, a temporal reference, a spatial reference, a signal quality reference) between devices of a RAN 104, which may support communication using physical channels. Reference signals communicated between network entities 108 and UEs 106 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 108 and UEs 106 may receive and measure transmitted reference signals to support one or more of these and other functions.

Devices of the wireless communication system 100 may be configured to support one or more aspects of the described techniques for optimization of channel information signaling over fronthaul links 126. For example, a DU 114 may include a processing system 136 and an RU 116 may include a processing system 138, each of which may be configured to cause the respective device to perform (such as being configured as means for performing) one or more of the described operations. In an example, each of the processing system 136 and the processing system 138 may include one or more memories and one or more processors coupled to the one or more memories, the one or more processors individually or collectively being configured to cause the respective device to perform (such as being configured as means for performing) one or more of the described operations. By configuring a processing system 136, a processing system 138, or a combination thereof in accordance with the described techniques, the wireless communication system 100 (such as the RAN 104) may support techniques for optimizing channel information signaling over fronthaul links 126 as described herein. For example, the wireless communication system 100 may enable a suppression of channel estimate transmission for inactive antennas from a DU 114 to an RU 116. Thus, the overhead in the fronthaul interface may be reduced, which in turn can enable to improve network performance, such as network latency, network bandwidth, or the like.

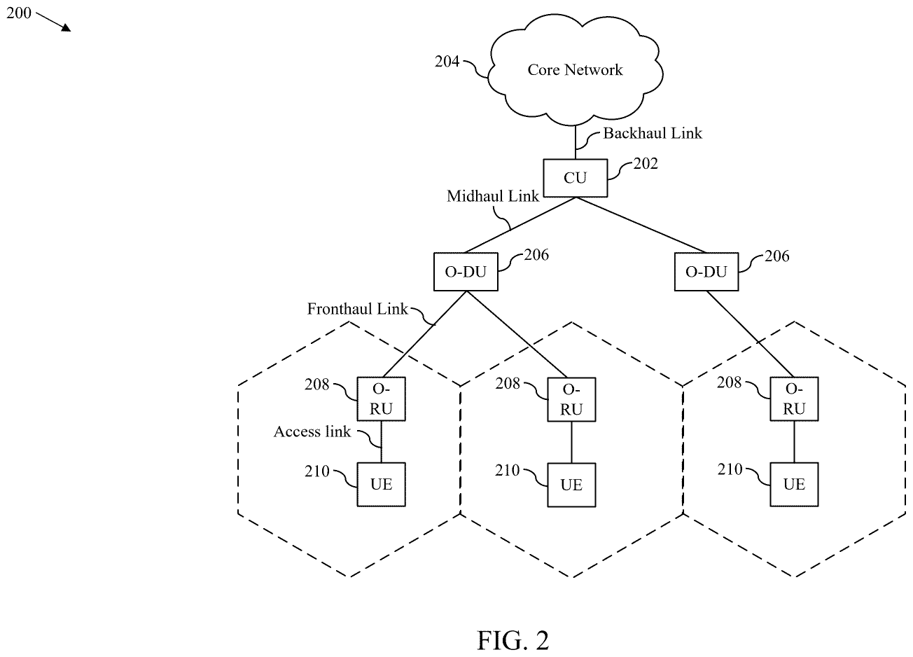

FIG. 2 is a diagram that illustrates an example of an Open Radio Access Network (O-RAN) architecture 200, in accordance with certain aspects of the present disclosure. In various aspects, the O-RAN architecture 200 may be implemented by one or more network entities of a wireless communication system, for example, the wireless communication system 100 of FIG. 1. In an example, the wireless communication system may include a 4G system, a 5G system, a 6G system, future generations, or the like. For example, a network node of the network nodes may include a New Radio (NR) base station, a Long-Term Evolution (LTE) base station, a NodeB, an eNB, a gNB, a RAN node, an access point, a transmission-reception point (TRP), a mobile entity of a wireless communication network, or the like. In an example, the O-RAN architecture 200 may correspond to disaggregated RAN architecture.

In various aspects, the O-RAN architecture 200 may include different network entities or nodes for wireless communication. For example, as shown in FIG. 2, the O-RAN architecture 200 may include a Central Unit (CU) 202 that is communicatively coupled to a core network 204 via a backhaul link (e.g., backhaul link 122 shown in FIG. 1). In an example, the CU 202 may be implemented within the network node of the one or more network nodes. Further, the O-RAN architecture 200 may include one or more O-RAN DUs (O-DUs) 206 and one or more O-RAN RUs (O-RUs) 208. The O-DUs 206 may be communicatively coupled to the CU 202 via a respective midhaul link (e.g., midhaul link 124 shown in FIG. 1). Further, the O-DUs 206 may be communicatively coupled to at least one corresponding O-RU of the O-RUs 208 via at least one respective fronthaul link (e.g., fronthaul link 126 shown in FIG. 1). In an example, the CU 202 may correspond to the CU 112 of FIG. 1, the O-DU 206 may correspond to the DU 114 of FIG. 1, and the O-RU 208 may correspond to the RU 116 of FIG. 1. The O-DUs 206 may be co-located with the CU 202, or alternatively, may be distributed across one or more different network nodes of the network nodes. Each of the O-RUs 208 may be co-located with a corresponding O-DU of the O-DUs 206, or alternatively, may be distributed across a different network node of the network nodes. Further, the O-RUs 208 may be communicatively coupled to at least one corresponding UE 210 via a respective radio frequency (RF) access link. Examples of the UE 210 may include a cellular phone, a personal digital assistant (PDA) device, a wireless modem, a wireless communication device, a handheld device, a laptop computer, a wireless local loop (WLL) station, a tablet, a camera, a gaming device, a wearable device, or the like.

In various aspects, the CU 202 may host one or more higher-layer control functions for network control, signaling, or a combination thereof. In an example, the higher-layer control functions may include Radio Resource Control (RRC) functions, Packet Data Convergence Protocol (PDCP) functions, Service Data Adaptation Protocol (SDAP) functions, or the like. Each higher-layer control function of the higher-layer control functions may be implemented with an interface that is configured to communicate signals with remaining higher-layer control functions hosted by the CU 202. Further, the CU 202 may be configured to handle a user plane functionality (for example, a Central Unit-User Plane (CU-UP) functionality), a control plane functionality (for example, a Central Unit-Control Plane (CU-CP) functionality), or a combination thereof. In some aspects, the CU 202 may be logically split into one or more CU-UP units and one or more CU-CP units to handle the user plane functionality and the control plane functionality, respectively. In some more aspects, the CU 202 may be implemented to communicate with the O-DUs 206 for the network control, signaling, or a combination thereof.

Each of the O-DUs 206 may correspond to a logical unit that includes one or more base station functions to control the operation of the corresponding O-RU of the O-RUs 208. In further aspects, each of the O-DUs 206 may host one or more of a Radio Link Control (RLC) layer, a MAC layer, and one or more high-physical (high-PHY) layers depending, at least in part, on a functional split, such as a functional split defined by the 3rd Generation Partnership Project (3GPP). Further, each layer hosted by an O-DU 206 of the O-DUs 206 may be implemented with an interface that is configured to communicate signals with remaining layers hosted by the O-DU 206, or with the higher-layer control functions hosted by the CU 202. In some implementations, the O-DUs 206 may host the high-PHY layers for forward error correction (FEC) encoding and decoding, scrambling, or modulation and demodulation, for example.

In some aspects, the O-DU 206 may be configured to receive an SRS associated with the UE 210. An SRS may indicate characteristics of a communication channel between a UE (for example, the UE 210) and a base station (for example, the O-DU 206, the O-RU 208, or a combination of the O-DU 206 and the O-RU 208). The characteristics of a communication channel may include path loss, delay spread, Doppler shift, signal-to-noise ratio, interference levels, multipath fading, angle of arrival, angle of departure, channel reciprocity, transmission power requirements, or the like. In various aspects, the O-DU 206 may receive the SRS from the UE 210 via the O-RU 208.

The O-DU 206 may be configured to generate a C-plane message based on the reception of the SRS. The C-plane message may indicate a first set of channel estimates for a set of active antennas of a plurality of antennas associated with the O-RU 208. Additionally, the C-plane message may not include channel estimates for a set of inactive antennas of the plurality of antennas. A channel estimate for an antenna may refer to a representation of a current state of a communication channel between the corresponding antenna and the UE 210. In an example, the channel estimate may be represented in a form of an amplitude and a phase of a signal that is received or transmitted through the channel for the corresponding antenna. Since the channel estimates for the set of inactive antennas are not included (e.g., are absent) in the C-plane message, a size of the C-plane message may be reduced in comparison to a C-plane message that includes channel estimates for both active antennas and inactive antennas.

The O-DU 206 may transmit the C-plane message to the O-RU 208. The C-plane message may be transmitted via the respective fronthaul link. As the C-plane message does not include the channel estimates for the set of inactive antennas, overhead in the fronthaul link is reduced.

Each of the O-RUs 208 may implement one or more lower-layer functionalities depending, at least in part, on the functional split defined by the 3GPP. The lower-layer functionalities may correspond to one or more low-physical (low-PHY) layer functions supported by a low-PHY layer or one or more RF processing functions. For example, the lower-layer functionalities may include performing a Fast Fourier Transform (FFT), performing an inverse Fast Fourier Transform (iFFT), digital beamforming, or Physical Random-Access Channel (PRACH) extraction and filtering. In some aspects, each O-RU of the O-RUs 208 may be controlled by the corresponding O-DU of the O-DUs 206 to handle over-the-air (OTA) communication with the UE 210. In some implementations, to handle the OTA communication, the O-DUs 206 may control one or more real-time, near real-time, or non-real-time aspects of C-plane communication, user plane (U-plane) communication, or a combination thereof with the O-RUs 208.

In some aspects, the O-RU 208 may be configured to transmit the SRS to the O-DU 206. In an example, the O-RU 208 may receive the SRS from the UE 210 and transmit the received SRS to the O-DU 206. The O-RU 208 may be further configured to receive the C-plane message from the O-DU 206 based on the transmission of the SRS. The C-plane message may indicate the first set of channel estimates for the set of active antennas associated with the O-RU 208. Additionally, the C-plane message may not include the channel estimates for the set of inactive antennas. In an example, the reception of the C-plane message by the O-RU 208 may be referred to as channel information signaling in fronthaul interface. The channel information signaling in the fronthaul interface is further explained in detail in conjunction with FIG. 2-12.

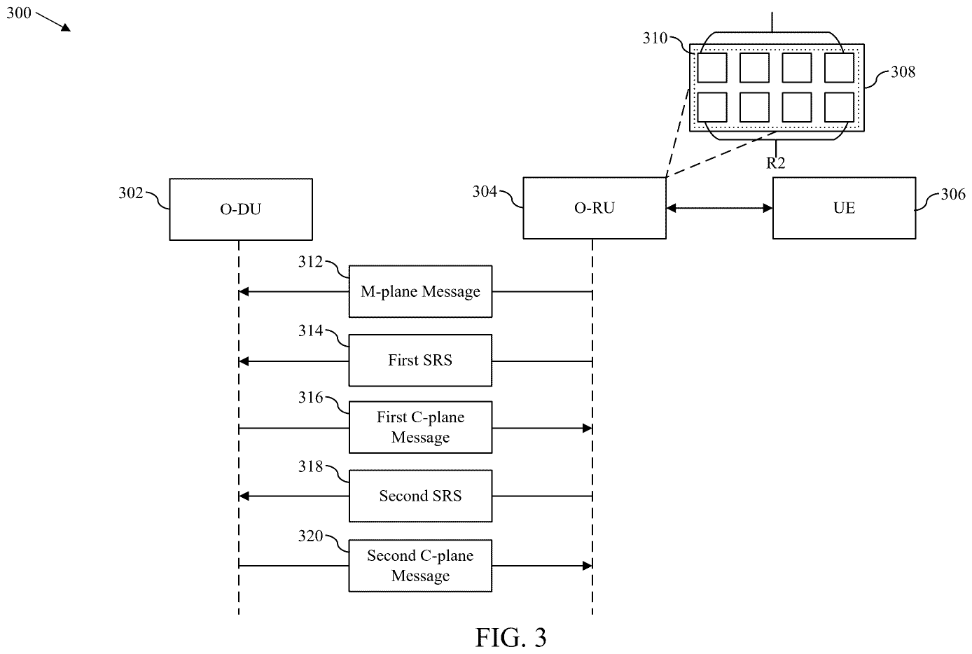

FIG. 3 is a diagram that illustrates an example of a message flow 300 between an O-DU 302 and an O-RU 304, in accordance with certain aspects of the present disclosure. The O-DU 302 may be structurally and functionally similar to the DU 114 of FIG. 1 or the O-DU 206 of FIG. 2. Further, the O-RU 304 may be structurally and functionally similar to the RU 116 of FIG. 1 or the O-RU 208 of FIG. 2. In various examples, the O-DU 302 and the O-RU 304 may be a part of the O-RAN architecture 200.

The O-DU 302 may be communicatively coupled to the O-RU 304 via a fronthaul interface (for example, the fronthaul link). As shown in FIG. 3, the O-RU 304 may be communicatively coupled to a UE 306. The UE 306 may be structurally and functionally similar to the UE 106 of FIG. 1 or the UE 210 of FIG. 2. Additionally, the O-RU 304 may be communicatively coupled to at least one antenna array 308. The antenna array 308 may include a plurality of antennas 310. Each antenna of the plurality of antennas 310 may be configured to transmit (or receive) at least one wireless signal. Examples of the plurality of antennas 310 may include patch antennas, dipole antennas, or the like, which can be arranged in a linear pattern, a two-dimensional pattern, or a different pattern. In a non-limiting example shown in FIG. 3, the plurality of antennas 310 may include eight antennas, with four antennas being arranged in each of a first row R1 and a second row R2 of the antenna array 308. That is to say, the plurality of antennas 310 may include first through eighth antennas with the first through fourth antennas being arranged in the first row R1 and the fifth through eighth antennas being arranged in the second row R2. The antenna array 308 may be integrated within a network node that hosts the O-RU 304, or alternatively, may be located outside the network node that hosts the O-RU 304.

In some aspects, the O-RU 304 may utilize the plurality of antennas 310 to perform wireless communication with the UE 306. In an example, the wireless communication may be performed by forming one or more beams using the plurality of antennas 310. In some examples, the beamforming may involve generating a beam by phase-shifting wireless signals associated with different antennas of the plurality of antennas 310. The generated beam may carry data, such as physical information or reference signal information, intended for communication with a receiving device, such as the UE 306. In an example, the generated beam may correspond to a directional signal that is transmitted in a direction of the receiving device.

In certain aspects, one or more first antennas among the plurality of antennas 310 may be active for performing the wireless communication with the UE 306. Additionally, or alternatively, one or more second antennas among the plurality of antennas 310 may be inactive while performing the wireless communication. Due to being inactive, the one or more second antennas may not contribute to the wireless communication. In some examples, the one or more second antennas may include the remaining antennas of the plurality of antennas 310 that are excluded from the one or more first antennas. In various examples, the one or more first antennas may remain active and the one or more second antennas may remain inactive based on one or more Quality of Service (QoS) policies supported by the O-DU 302 (or the O-RU 304). For example, the QoS policies may include a network coverage policy, a UE handover policy, an energy-saving policy, or the like. Hereinafter, the one or more first antennas may be referred to as the “first set of active antennas” and the one or more second antennas may be referred to as the “first set of inactive antennas” based on corresponding operational status (e.g., active or inactive). In an example, the first set of active antennas corresponds to the one or more first antennas among the plurality of antennas 310 that are switched ON, and the first set of inactive antennas corresponds to the one or more second antennas among the plurality of antennas 310 that are switched OFF. For the sake of ongoing discussion, it is assumed that the first set of active antennas may include the first antenna, the second antenna, the sixth antenna, and the seventh antenna. Additionally, the first set of inactive antennas may include the third antenna, the fourth antenna, the fifth antenna, and the eighth antenna.

In the aspects shown in FIG. 3, the message flow 300 may include transmitting a management plane (M-plane) message 312. An M-plane message may be associated with management of an O-RU. In various aspects, the O-RU 304 may be configured to transmit the M-plane message 312 to the O-DU 302. The M-plane message 312 may include a first capability indicator specifying that the O-RU 304 may support channel estimate information associated with the plurality of antennas 310 in a reduced format. For example, the O-DU 302 may be configured to receive the first capability indicator via the M-plane message 312 from the O-RU 304. The channel estimate information in the reduced format may refer to channel estimate information associated with the first set of active antennas. The channel estimate information in the reduced format may not include or be independent of channel estimate information associated with the first set of inactive antennas. In some examples, the M-plane message 312 may further include various configurations associated with the O-RU 304. In further examples, the M-plane message 312 may be transmitted by the O-RU 304 based on a power-ON of the O-RU 304, or restarting of the O-RU 304.

In an example, the first capability indicator may correspond to a flag in the M-plane message 312. For example, the first capability indicator may indicate a first configured value (e.g., a Boolean value of ‘1’) to specify that the O-RU 304 may support the channel estimate information associated with the plurality of antennas 310 in the reduced format. Additionally, or alternatively, the first capability indicator may indicate a second configured value (e.g., a Boolean value of ‘0’) to specify that the O-RU 304 does not support the channel estimate information associated with the plurality of antennas 310 in the reduced format.

In further aspects, the message flow 300 may include receiving a first SRS 314. In various aspects, the O-DU 302 may be configured to receive the first SRS 314 associated with the UE 306. The first SRS 314 may be received from the O-RU 304. For example, the O-RU 304 may be configured to transmit the first SRS 314 to the O-DU 302. In some examples, the first SRS 314 may be transmitted to the O-RU 304 by the UE 306, and the O-RU 304 may transmit the first SRS 314 received from the UE 306 to the O-DU 302. An SRS may indicate characteristics of a communication channel between a UE (for example, the UE 306) and a base station (for example, the O-DU 302, the O-RU 304, or a combination of the O-DU 302 and the O-RU 304). The characteristics of the communication channel may include path loss, delay spread, Doppler shift, signal-to-noise ratio, interference levels, multipath fading, angle of arrival, angle of departure, channel reciprocity, transmission power requirements, or the like. In various examples, an SRS may be periodically received by the O-DU 302. In some examples, the first SRS 314 may indicate the characteristics of the channel between the UE 306 and the base station (for example, the O-DU 302, the O-RU 304, or the combination of the O-DU 302 and the O-RU 304) at a first time instance.

After the reception of the first SRS 314, the O-DU 302 may be configured to generate a first C-plane message 316 based on the first SRS 314. The first C-plane message 316 may indicate a first set of channel estimates for the first set of active antennas of the plurality of antennas 310. Further, the first C-plane message 316 may not include channel estimates for the first set of inactive antennas of the plurality of antennas 310. In some examples, the generation of the first C-plane message 316 may be further based on the first capability indicator received via the M-plane message 312. Thus, the O-DU 302 may generate the first C-plane message 316 in which the first set of channel estimates is present and the channel estimates of the first set of inactive antennas are not included (e.g., are absent) based on the first capability indicator specifying that the O-RU 304 may support the channel estimate information associated with the plurality of antennas 310 in the reduced format. The channel estimate information in the reduced format may exclusively indicate the first set of channel estimates for the first set of active antennas.

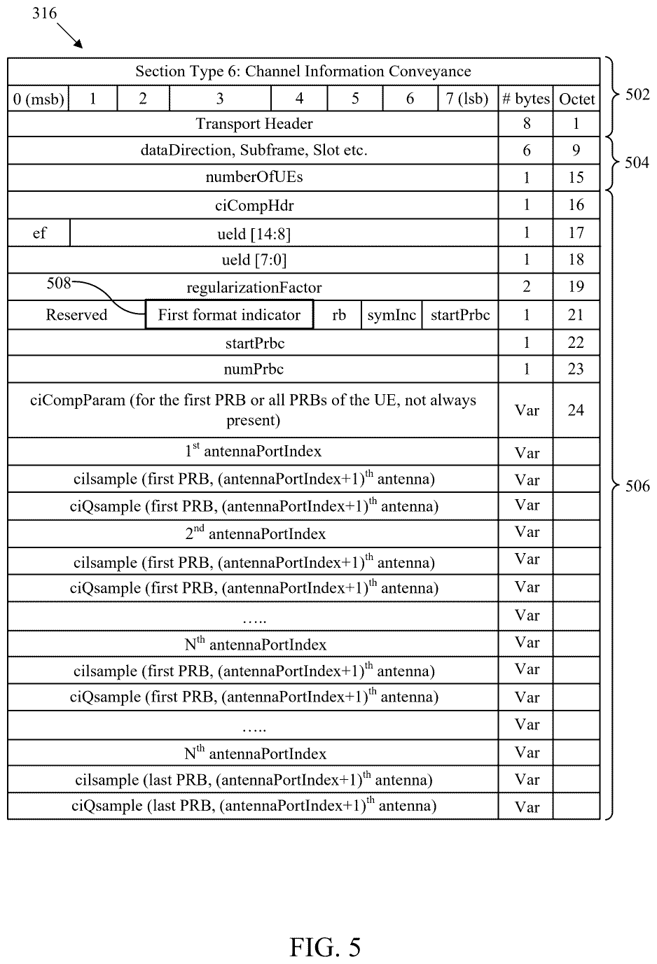

A channel estimate for an antenna of the plurality of antennas 310 may refer to a representation of a current state of a communication channel between the corresponding antenna and the UE 306. In various examples, the first C-plane message 316 may correspond to a Section Type 6 (ST6) message. A structure of the first C-plane message 316 is described in conjunction with FIG. 5. As the channel estimates of the first set of inactive antennas of the plurality of antennas 310 are not included (or are absent) in the first C-plane message 316, a size of the first C-plane message 316 is reduced in comparison to a C-plane message that includes channel estimate information for the plurality of antennas 310. In certain aspects, the O-DU 302 may be configured to store the first set of channel estimates in a memory associated with the O-DU 302.

In some examples, the O-DU 302 may determine the first set of channel estimates based on various techniques such as Least-Squares (LS) Estimation, Minimum Mean Square Error (MMSE) Estimation, Linear Interpolation/Interpolation-Based Estimation, Time or Frequency Domain Smoothing, Frequency Domain Channel Estimation, or a combination thereof. In further aspects, the first C-plane message 316 may include a first format indicator to specify that the first C-plane message 316 includes the channel estimate information in the reduced format. In various aspects, the first format indicator in the first C-plane message 316 may specify that the first C-plane message 316 does not include channel estimate information for the first set of inactive antennas of the plurality of antennas 310.

In some aspects, in the first C-plane message 316, each channel estimate of the first set of channel estimates may be associated with an antenna identifier of a corresponding active antenna of the first set of active antennas. More particularly, in the first C-plane message 316, an indication that a channel estimate of the first set of channel estimates corresponds to an active antenna of the first set of active antennas may be provided by way of an antenna identifier of the active antenna. For example, a first channel estimate of the first set of channel estimates may be associated with a first antenna identifier of the first antenna in the first C-plane message 316. In some more aspects, the first format indicator in the first C-plane message 316 may further indicate that in the first C-plane message 316, each channel estimate of the first set of channel estimates is associated with the antenna identifier of the corresponding active antenna of the first set of active antennas.

In numerous aspects, each channel estimate of the first set of channel estimates may be associated with a first plurality of physical resource blocks (PRBs) associated with the UE 306. Each channel estimate of the first set of channel estimates may be defined by I (in-phase) and Q (quadrature) components for each PRB of the first plurality of PRBs utilized to control the amplitude, the phase, or a combination thereof of the wireless signal associated with the respective antenna of the first set of active antennas. A PRB may correspond to frequency-time resources (comprising subcarriers and time slots) allocated to a UE for data transmission with an O-RU, an O-DU, or a combination of the O-RU and the O-DU.

The message flow 300 may include transmitting the first C-plane message 316. In various aspects, the O-DU 302 may be configured to transmit the first C-plane message 316 to the O-RU 304. In some aspects, the O-RU 304 may be configured to receive the first C-plane message 316 from the O-DU 302 in response to the transmission of the first SRS 314. The first C-plane message 316 may be transmitted in the fronthaul interface. As the channel estimates for the first set of inactive antennas of the plurality of antennas 310 are not included (e.g., are absent) in the first C-plane message 316, resources utilized for the transmission of the first C-plane message 316 in the fronthaul interface may be reduced in comparison to resources utilized for transmission of C-plane messages that include channel estimates of both active and inactive antennas. Thus, channel information signaling in the fronthaul interface may be optimized.

Since the channel estimates for the first set of inactive antennas are not communicated to the O-RU 304 over the fronthaul interface, the overhead in the fronthaul interface may be reduced, which in turn enables to improve network performances, such as network latency, network bandwidth, or the like.

The O-RU 304 may be configured to receive the first C-plane message 316 from the O-DU 302. As described above, the first C-plane message 316 received by the O-RU 304 may indicate the first set of channel estimates for the first set of active antennas of the plurality of antennas 310 associated with the O-RU 304. In various aspects, the O-RU 304 may identify that a channel estimate of the first set of channel estimates is for a corresponding antenna of the plurality of antennas 310 based on the association between the corresponding channel estimate and the corresponding antenna identifier indicated in the first C-plane message 316.

In some aspects, the O-RU 304 may determine a first set of beamforming weights for the first set of active antennas based on the first C-plane message 316. In various examples, each beamforming weight of the first set of beamforming weights may represent a set of complex coefficient values, defined by I (in-phase) and Q (quadrature) components, utilized to control the amplitude, the phase, or a combination thereof of the wireless signal associated with the respective antenna of the first set of active antennas.

In some examples, the first set of beamforming weights may be determined by executing one or more beamforming algorithms, such as the MMSE algorithm, the Max-SNR algorithm, or the like. In an example, the O-RU 304 may execute the beamforming algorithms based on the first set of channel estimates indicated in the first C-plane message 316. In some more examples, the O-RU 304 may be configured to determine the first set of beamforming weights for the first set of active antennas while prohibiting the determination of beamforming weights for the first set of inactive antennas. In these examples, by prohibiting the determination of the beamforming weights for the first set of inactive antennas, the demand for the computation resources of the O-RU 304 can be reduced. In an example, the first set of beamforming weights for the first set of active antennas may include a beamforming weight (e.g., a set of complex coefficient values, “0.72, 0.76”) for the first antenna, a beamforming weight (e.g., a set of complex coefficient values, “0.94, 0.92”) for the second antenna, a beamforming weight (e.g., a set of complex coefficient values, “0.84, 0.82”) for the sixth antenna, and a beamforming weight (e.g., a set of complex coefficient values, “0.88, 0.90”) for the seventh antenna. In various aspects, the O-RU 304 may be configured to store the first set of beamforming weights in a memory associated with the O-RU 304.

In some aspects, the O-RU 304 may be configured to determine a set of zero beamforming weights for the first set of inactive antennas of the plurality of antennas 310 based on the first C-plane message 316. The set of zero beamforming weights may include a set of complex coefficient values, “0, 0” for each inactive antenna of the first set of inactive antennas. In various examples, the O-RU 304 may identify the first set of inactive antennas based on the first C-plane message 316. For example, the O-RU 304 may identify one or more antennas among the plurality of antennas 310 whose antenna identifiers are not included (e.g., are absent) in the first C-plane message 316.

Upon generating the first set of beamforming weights for the first set of active antennas, the O-RU 304 may be configured to control the plurality of antennas 310 based on the first set of beamforming weights. In some examples, the O-RU 304 may control the plurality of antennas 310 further based on the set of zero beamforming weights. In various examples, the control of the plurality of antennas 310 may include configuring (or assigning) the first set of active antennas of the plurality of antennas 310 with the first set of beamforming weights. In some more examples, the control of the plurality of antennas 310 may include either activating or deactivating each antenna of the plurality of antennas 310 based on the first C-plane message 316. The activation of an antenna of the plurality of antennas 310 may include changing the antenna from an OFF state to an ON state. Alternatively, if the antenna is already in the active state, the activation of the antenna may include maintaining the antenna in the ON state. Similarly, the deactivation of the antenna may either include changing the antenna from the ON state to the OFF state or maintaining the antenna in the inactive state.

Upon controlling the plurality of antennas 310, the O-RU 304 may be configured to communicate with the UE 306 based on the control of the plurality of antennas 310. In various examples, the communication with the UE 306 may be via the first set of active antennas (e.g., the first antenna, the second antenna, the sixth antenna, and the seventh antenna) of the plurality of antennas 310. In an example, the data intended for the UE 306 may be communicated via one or more beams formed by the first set of active antennas.

The transmission of the first capability indicator may assist the O-DU 302 in identifying whether an O-RU of the O-RAN architecture 200 supports the channel estimate information associated with the plurality of antennas 310 in the reduced format or not. Accordingly, if the O-RAN architecture 200 includes one or more O-RUs that do not support the channel estimate information in the reduced format, the transmission of the first capability indicator may enable the O-DU 302 to communicate, to the one or more O-RUs, a fourth C-plane message that indicates channel estimates for both the first set of active antennas and the first set of inactive antennas. Consequently, the transmission of the first capability indicator, specifying that the O-RU 304 does not support the channel estimate information in the reduced format, may enable the O-DU 302 to communicate channel estimates without compromising on the network reliability.

The message flow 300 may include receiving a second SRS 318 associated with the UE 306. In various aspects, the O-DU 302 may be configured to receive the second SRS 318 associated with the UE 306. The second SRS 318 may be received after the reception of the first SRS 314. In some examples, the second SRS 318 may be received from the UE 306 via the O-RU 304. In some examples, the second SRS 318 may indicate the characteristics of the channel between the UE 306 and the base station (for example, the O-DU 302, the O-RU 304, or the combination of the O-DU 302 and the O-RU 304) at a second time instance.

After the reception of the second SRS 318, the O-DU 302 may be configured to determine a second set of channel estimates for the first set of active antennas based on the second SRS 318. Further, the O-DU 302 may be configured to generate a second C-plane message 320 based on the second SRS 318. The second C-plane message 320 may indicate one or more channel estimates of the determined second set of channel estimates. The one or more channel estimates of the determined second set of channel estimates may deviate from corresponding one or more channel estimates of the first set of channel estimates. Additionally, the second C-plane message 320 may not include at least one channel estimate of the second set of channel estimates that is same as a corresponding channel estimate of the first set of channel estimates.

In various aspects, the O-DU 302 may be configured to compare the second set of channel estimates with the first set of channel estimates stored in the memory associated with the O-DU 302. Further, the second C-plane message 320 may be generated based on the comparison of the second set of channel estimates with the first set of channel estimates. That is to say, the O-DU 302 may identify the one or more channel estimates of the second set of channel estimates that deviate from the corresponding one or more channel estimates of the first set of channel estimates based on the comparison. Similarly, the O-DU 302 may identify the at least one channel estimate of the second set of channel estimates that is same as the corresponding channel estimate of the first set of channel estimates based on the comparison.

In some examples, the one or more channel estimates of the determined second set of channel estimates may deviate from the corresponding one or more channel estimates of the first set of channel estimates beyond a threshold value. In some more examples, the channel estimate of the second set of channel estimates that is same as the corresponding channel estimate of the first set of channel estimates may correspond to the channel estimate of the second set of channel estimates that deviates from the corresponding channel estimate of the first set of channel estimates below the threshold value.

In some examples, channel estimates of the second set of channel estimates for the second antenna and the seventh antenna may be the same as channel estimates of the first set of channel estimates for the second antenna and the seventh antenna. In such examples, the second C-plane message 320 may include channel estimates of the second set of channel estimates for the first and sixth antennas of the first set of active antennas. Since the second C-plane message 320 does not include the channel estimates that are the same as the corresponding channel estimates in the first C-plane message 316, a size of the second C-plane message 320 is lesser than the size of the first C-plane message 316.

In certain aspects, the second C-plane message 320 may include a composition indicator that may specify that the second C-plane message 320 may not include channel estimates for active antennas whose channel estimates are same as the corresponding channel estimates in the first C-plane message 316.

The message flow 300 may include transmission of the second C-plane message 320. In various aspects, the O-DU 302 may be configured to transmit the second C-plane message 320 to the O-RU 304. As the second C-plane message 320 may not include the channel estimates for active antennas whose channel estimates are same as the corresponding channel estimates in the first C-plane message 316, the overhead in the fronthaul between the O-DU 302 and the O-RU 304 may be further reduced.

In some aspects, the O-RU 304 may be further configured to receive the second C-plane message 320. The O-RU 304 may be configured to generate one or more beamforming weights for one or more active antennas of the first set of active antennas based on the one or more channel estimates in the second C-plane message 320. The O-RU 304 may control the one or more active antennas based on the one or more beamforming weights. The O-RU 304 may utilize one or more beamforming weights of the first set of beamforming weights that are stored in the memory associated with the O-RU 304 to control one or more active antennas whose channel estimates are not included in the second C-plane message 320 based on the specification indicator of the second C-plane message 320.

In numerous aspects, the message flow 300 may include transmission of a third C-plane message that may be indicative of the first set of active antennas and the first set of inactive antennas, among the plurality of antennas 310. The third C-plane message may be transmitted by the O-DU 302 to the O-RU 304 prior to the transmission of the first C-plane message 316. In various examples, the third C-plane message may correspond to a Section Type 4 (ST4) message (for example, an ST4 (cmdtype3) message) utilized for configuring or managing the wireless communication. In various additional examples, a different M-plane message that may be indicative of the first set of active antennas and the first set of inactive antennas, among the plurality of antennas 310 may be transmitted by the O-DU 302 to the O-RU 304 instead of the third C-plane message.

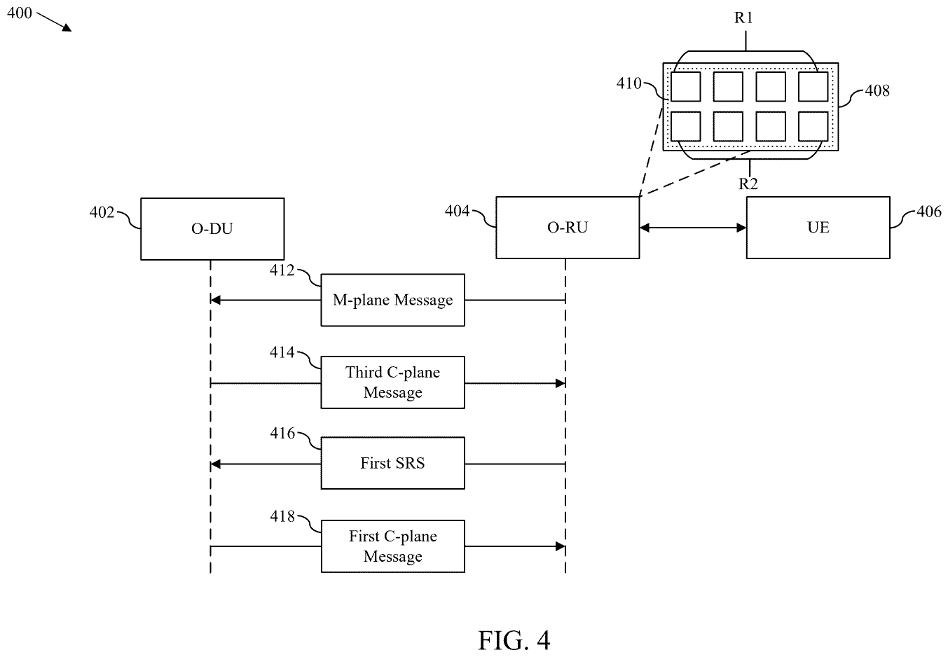

FIG. 4 is a diagram that illustrates an example of a message flow 400 between an O-DU 402 and an O-RU 404, in accordance with certain aspects of the present disclosure. The O-DU 402 may be structurally and functionally similar to the DU 114 of FIG. 1 or the O-DU 206 of FIG. 2. Further, the O-RU 404 may be structurally and functionally similar to the RU 116 of FIG. 1 or the O-RU 208 of FIG. 2. In various examples, the O-DU 402 and the O-RU 404 may be a part of the O-RAN architecture 200.

The O-DU 402 may be communicatively coupled to the O-RU 404 via a fronthaul interface (for example, the fronthaul link). As shown in FIG. 4, the O-RU 404 may be communicatively coupled to a UE 406. The UE 406 may be structurally and functionally similar to the UE 106 of FIG. 1 or the UE 210 of FIG. 2. Additionally, the O-RU 404 may be communicatively coupled to at least one antenna array 408. The antenna array 408 may include a plurality of antennas 410. Each antenna of the plurality of antennas 410 may be configured to transmit (or receive) at least one wireless signal. Examples of the plurality of antennas 410 may include patch antennas, dipole antennas, or the like, which can be arranged in a linear pattern, a two-dimensional pattern, or a different pattern. In a non-limiting example shown in FIG. 4, the plurality of antennas 410 may include eight antennas, with four antennas being arranged in each of a first row R1 and a second row R2 of the antenna array 408. That is to say, the plurality of antennas 410 may include ninth through sixteenth antennas with the ninth through twelfth antennas being arranged in the first row R1 and the thirteenth through sixteenth antennas being arranged in the second row R2. The antenna array 408 may be integrated within a network node that hosts the O-RU 404, or alternatively, may be located outside the network node that hosts the O-RU 404.

In some aspects, the O-RU 404 may utilize the plurality of antennas 410 to perform wireless communication with the UE 406. In an example, the wireless communication may be performed by forming one or more beams using the plurality of antennas 410. In some examples, the beamforming may involve generating a beam by phase-shifting wireless signals associated with different antennas of the plurality of antennas 410. The generated beam may carry data, such as physical information or reference signal information, intended for communication with a receiving device, such as the UE 406. In an example, the generated beam may correspond to a directional signal that is transmitted in a direction of the receiving device.

In certain aspects, one or more third antennas among the plurality of antennas 410 may be active for performing the wireless communication with the UE 406. Additionally, or alternatively, one or more fourth antennas among the plurality of antennas 410 may be inactive while performing the wireless communication. Due to being inactive, the one or more fourth antennas may not contribute to the wireless communication. In some examples, the one or more fourth antennas may include the remaining antennas of the plurality of antennas 410 that are excluded from the one or more third antennas. In various examples, the one or more third antennas may remain active and the one or more fourth antennas may remain inactive based on one or more Quality of Service (QoS) policies supported by the O-DU 402 (or the O-RU 404). For example, the QoS policies may include a network coverage policy, a UE handover policy, an energy-saving policy, or the like. Hereinafter, the one or more third antennas may be referred to as the “second set of active antennas” and the one or more fourth antennas may be referred to as the “second set of inactive antennas” based on corresponding operational status (e.g., active or inactive). That is to say, the second set of active antennas corresponds to the one or more third antennas among the plurality of antennas 410 that are switched ON, and the second set of inactive antennas corresponds to the one or more fourth antennas among the plurality of antennas 410 that are switched OFF. For the sake of ongoing discussion, it is assumed that the second set of active antennas may include the ninth antenna, the tenth antenna, the fifteenth antenna, and the sixteenth antenna. Additionally, the second set of inactive antennas may include the eleventh through fourteenth antennas.

In the aspects shown in FIG. 4, the message flow 400 may include transmitting an M-plane message 412. An M-plane message may be associated with management of an O-RU. In various aspects, the O-RU 404 may be configured to transmit the M-plane message 412 to the O-DU 402. The M-plane message 412 may include a second capability indicator specifying that the O-RU 404 may support channel estimate information associated with the plurality of antennas 410 in a reduced format. Thus, the O-DU 402 may be configured to receive the second capability indicator via the M-plane message 412 from the O-RU 404. The channel estimate information in reduced format may refer to channel estimate information associated with the second set of active antennas. Thus, the channel estimate information in the reduced format may not include channel estimate information associated with the second set of inactive antennas. In some examples, the M-plane message 412 may further include various configurations associated with the O-RU 404. In further examples, the M-plane message 412 may be transmitted by the O-RU 404 based on a power-ON of the O-RU 404, or restarting of the O-RU 404.

In an example, the second capability indicator may correspond to a flag in the M-plane message 412. For example, the second capability indicator may indicate a third configured value (e.g., a Boolean value of ‘1’) to specify that the O-RU 404 may support the channel estimate information associated with the plurality of antennas 410 in the reduced format. Additionally, or alternatively, the second capability indicator may indicate a fourth configured value (e.g., a Boolean value of ‘0’) to specify that the O-RU 404 does not support the channel estimate information associated with the plurality of antennas 410 in the reduced format.

In further aspects, the message flow 400 may include transmission of a third C-plane message 414. In various aspects, the O-DU 402 may be configured to transmit the third C-plane message 414 associated with the plurality of antennas 410 to the O-RU 404. In some examples, the O-DU 402 may be configured to generate the third C-plane message 414 prior to the transmission of the third C-plane message 414 to the O-RU 404. In an example, the third C-plane message 414 may correspond to an ST4 message (for example, an ST4 (cmdtype3) message) utilized for configuring or managing the wireless communication. In various examples, the third C-plane message 414 may indicate the second set of active antennas and the second set of inactive antennas, among the plurality of antennas 410.

In some aspects, to generate the third C-plane message 414, the O-DU 402 may be configured to generate a bitmap for the plurality of antennas 410. In some examples, the bitmap may include a plurality of bits for the plurality of antennas 410, respectively. For example, each bit of the plurality of bits may be mapped to a corresponding antenna of the plurality of antennas 410. The plurality of bits may include a first set of bits, each with a first value (for example, a Boolean value of ‘1’), indicating the second set of active antennas of the plurality of antennas 410. The plurality of bits may further include a second set of bits, each with a second value (for example, a Boolean value of ‘0’), indicating the second set of inactive antennas of the plurality of antennas 410. Thus, each bit of the plurality of bits may have one of the first value indicating that the corresponding antenna is active, or the second value indicating that the corresponding antenna is inactive.

In some more examples, the plurality of bits in the bitmap may be in a specific sequence, and each bit in the bitmap may correspond to a specific antenna among the plurality of antennas 410. The sequence of the plurality of bits in the bitmap may depend on positions of the plurality of antennas 410 in the antenna array 408. For example, the Most Significant Bit (MSB) in the bitmap may correspond to the leftmost antenna in the first row R1 of the antenna array 408 and the Least Significant Bit (LSB) in the bitmap may correspond to the rightmost antenna in a last row (e.g., the second row R2) of the antenna array 408. Mapping between the plurality of antennas 410 and the plurality of bits in the bitmap may follow an order defined by the positions of the plurality of antennas 410 in the antenna array 408.

In a non-limiting example, the bitmap may be denoted as “{1100 0011}” with ‘0’s indicating the second set of inactive antennas (e.g., the eleventh through fourteenth antennas) and ‘1’s indicating the second set of active antennas (e.g., the ninth antenna, the tenth antenna, the fifteenth antenna, and the sixteenth antenna). Upon generating the bitmap, the O-DU 402 may configure the third C-plane message 414 to include the bitmap. Accordingly, the third C-plane message 414 may indicate the second set of active antennas and the second set of inactive antennas of the plurality of antennas 410.

In some aspects, a different M-plane message that may be indicative of the second set of active antennas and the second set of inactive antennas, among the plurality of antennas 410, may be transmitted by the O-DU 402 to the O-RU 404 instead of the third C-plane message 414.

In further aspects, the message flow 400 may include receiving a first SRS 416. In various aspects, the O-DU 402 may be configured to receive the first SRS 416 associated with the UE 406. The first SRS 416 may be received from the O-RU 404. For example, the O-RU 404 may be configured to transmit the first SRS 416 to the O-DU 402. In some examples, the first SRS 416 may be transmitted to the O-RU 404 by the UE 406, where the O-RU 404 may transmit the first SRS 416 received from the UE 406 to the O-DU 402. An SRS may indicate characteristics of a communication channel between a UE (for example, the UE 406) and a base station (for example, the O-DU 402, the O-RU 404, or a combination of the O-DU 402 and the O-RU 404). The characteristics of the communication channel may include path loss, delay spread, Doppler shift, signal-to-noise ratio, interference levels, multipath fading, angle of arrival, angle of departure, channel reciprocity, transmission power requirements, or the like.

After the reception of the first SRS 416, the O-DU 402 may be configured to generate a first C-plane message 418 based on the first SRS 416. The first C-plane message 418 may indicate a third set of channel estimates for the second set of active antennas of the plurality of antennas 410. Further, channel estimates for the second set of inactive antennas of the plurality of antennas 410 may be absent in the first C-plane message 418. That is to say, the first C-plane message 418 may not include the channel estimates for the second set of inactive antennas of the plurality of antennas 410. In some examples, the generation of the first C-plane message 418 may be further based on the second capability indicator received via the M-plane message 412. That is to say, the O-DU 402 may generate the first C-plane message 418 in which the third set of channel estimates is present and the channel estimates for the second set of inactive antennas of the plurality of antennas 410 are absent based on the second capability indicator specifying that the O-RU 404 may support the channel estimate information associated with the plurality of antennas 410 in the reduced format. The channel estimate information in the reduced format exclusively indicates the third set of channel estimates for the second set of active antennas.

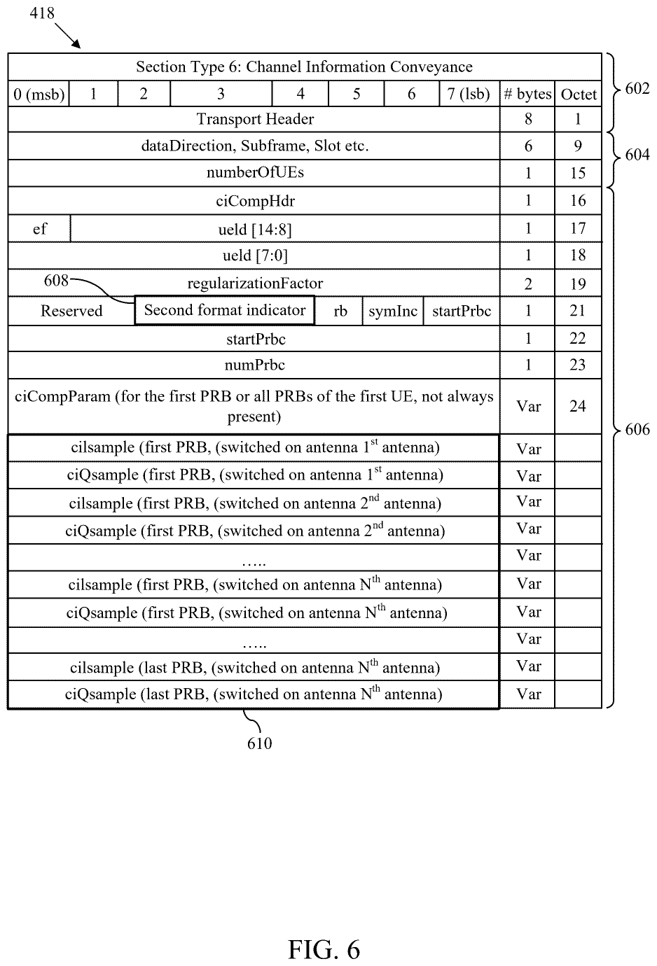

A channel estimate for an antenna of the plurality of antennas 410 may refer to a representation of a current state of a communication channel between the corresponding antenna and the UE 406. In various examples, the first C-plane message 418 may correspond to an ST6 message. A structure of the first C-plane message 418 is described in conjunction with FIG. 6. As the channel estimates for the second set of inactive antennas of the plurality of antennas 410 are not included in the first C-plane message 418, a size of the first C-plane message 418 is reduced in comparison to a conventional C-plane message that includes channel estimate information for the plurality of antennas 410.

In some examples, the O-DU 402 may determine the third set of channel estimates based on various techniques such as the LS Estimation, the MMSE Estimation, the Linear Interpolation/Interpolation-Based Estimation, the Time or Frequency Domain Smoothing, the Frequency Domain Channel Estimation, or a combination thereof.

In some examples, in the first C-plane message 418, the third set of channel estimates for the second set of active antennas may be indicated in a same sequence in which the second set of active antennas is indicated in the bitmap of the third C-plane message 414. Thus, in the first C-plane message 418, occurrences of the third set of channel estimates may follow the same sequence in which the second set of active antennas is indicated in the third C-plane message 414. For example, if the ninth antenna is indicated prior to the tenth antenna in the third C-plane message 414, an occurrence of the channel estimate for the ninth antenna may also be prior to an occurrence of the channel estimate for the tenth antenna in the first C-plane message 418. In the aspects described in FIG. 4, the third set of channel estimates in the first C-plane message 418 may be denoted in a sequence such as “{0.72, 0.76; 0.94, 0.92; 0.82, 0.84; 0.86, 0.88}” with ‘0.72, 0.76’ being the channel estimate of the ninth antenna, ‘0.94, 0.92’ being the channel estimate of the tenth antenna, ‘0.82, 0.84’ being the channel estimate of the fifteenth antenna, and ‘0.86, 0.88’being the channel estimate of the sixteenth antenna.

In various aspects, the first C-plane message 418 may include a second format indicator that may specify that the first C-plane message 418 may include the channel estimate information for the plurality of antennas 410 in the reduced format. In some examples, the channel estimate information in the reduced format may exclusively indicate the third set of channel estimates for the second set of active antennas. In further aspects, the second format indicator may further specify that the third set of channel estimates is in a same sequence as the second set of active antennas in the third C-plane message 414.

In numerous aspects, each channel estimate of the third set of channel estimates may be associated with a second plurality of PRBs associated with the UE 406. That is to say, each channel estimate of the third set of channel estimates may be defined by I (in-phase) and Q (quadrature) components for each PRB of the second plurality of PRBs.

The message flow 400 may include transmitting the first C-plane message 418. In various aspects, the O-DU 402 may be configured to transmit the first C-plane message 418 to the O-RU 404. Thus, the O-RU 404 may be configured to receive the first C-plane message 418 from the O-DU 402. In various examples, the first C-plane message 418 may be transmitted via the fronthaul interface. As the channel estimates for the second set of inactive antennas of the plurality of antennas 410 are not included in the first C-plane message 418, resources utilized for the transmission of the first C-plane message 418 in the fronthaul interface may be reduced in comparison to resources utilized for transmission of the conventional C-plane message. Thus, channel information signaling in the fronthaul interface may be optimized.

Since the channel estimates for the second set of inactive antennas are not communicated to the O-RU 404 over the fronthaul interface, the overhead in the fronthaul interface may be reduced, which in turn improves network performances, such as network latency, network bandwidth, or the like.

The O-RU 404 may be configured to receive the first C-plane message 418 from the O-DU 402 in response to the transmission of the first SRS 416. As described above, the first C-plane message 418 received by the O-RU 404 may indicate the third set of channel estimates for the second set of active antennas of the plurality of antennas 410 associated with the O-RU 404. Further, the channel estimates for the second set of inactive antennas of the plurality of antennas 410 may not be included in the first C-plane message 418. In various aspects, the O-RU 404 may identify that a channel estimate of the third set of channel estimates is for a corresponding antenna of the plurality of antennas 410 based on the sequence of the second set of active antennas in the third C-plane message 414.

In some aspects, the O-RU 404 may determine a second set of beamforming weights for the second set of active antennas based on the first C-plane message 418. In various examples, each beamforming weight of the second set of beamforming weights may represent a set of complex coefficient values, defined by I (in-phase) and Q (quadrature) components, utilized to control the amplitude, the phase, or both of the wireless signal associated with the respective antenna of the second set of active antennas of the plurality of antennas 410.

In some examples, the second set of beamforming weights may be determined by executing one or more beamforming algorithms, such as the MMSE algorithm, the Max-SNR algorithm, or the like. In an example, the O-RU 404 may execute the beamforming algorithms based on the third set of channel estimates indicated in the first C-plane message 418. In some more examples, the O-RU 404 may be configured to determine the second set of beamforming weights for the second set of active antennas while prohibiting the determination of beamforming weights for the second set of inactive antennas. In these examples, by prohibiting the determination of the beamforming weights for the second set of inactive antennas, the demand for the computation resources of the O-RU 404 can be reduced.

In some aspects, the O-RU 404 may be configured to determine a set of zero beamforming weights for the second set of inactive antennas of the plurality of antennas 410 based on the first C-plane message 418. The set of zero beamforming weights may include a set of complex coefficient values, “0, 0 ” for each inactive antenna of the second set of inactive antennas. In various examples, the O-RU 404 may identify the second set of inactive antennas based on the third C-plane message 414. In more examples, the O-RU 404 may identify one or more antennas among the plurality of antennas 410 whose corresponding bit in the plurality of bits has the second value (for example, a Boolean value of ‘0’).

Upon generating the second set of beamforming weights for the second set of active antennas, the O-RU 404 may be configured to control the plurality of antennas 410 based on the second set of beamforming weights. In some examples, the O-RU 404 may control the plurality of antennas 410 further based on the set of zero beamforming weights. In some examples, the control of the plurality of antennas 410 may include configuring (or assigning) the second set of active antennas of the plurality of antennas 410 with the second set of beamforming weights. In some more examples, the control of the plurality of antennas 410 may include either activating or deactivating each antenna of the plurality of antennas 410 based on the third C-plane message 414 and the first C-plane message 418. The activation of an antenna of the plurality of antennas 410 may include changing the antenna from an OFF state to an ON state. Alternatively, if the antenna is already in the active state, the activation of the antenna may include maintaining the antenna in the ON state. Similarly, the deactivation of the antenna may either include changing the antenna from the ON state to the OFF state or maintaining the antenna in the inactive state.

In many aspects, the O-RU 404 may be configured to communicate with the UE 406 based on the control of the plurality of antennas 410. In various examples, the communication with the UE 406 may be via the second set of active antennas (e.g., the ninth antenna, the tenth antenna, the fifteenth antenna, and the sixteenth antenna) of the plurality of antennas 410. In an example, the data intended for the UE 406 may be communicated via one or more beams formed by the second set of active antennas.

The transmission of the second capability indicator may assist the O-DU 402 in identifying whether an O-RU of the O-RAN architecture 200 supports the channel estimate information associated with the plurality of antennas 410 in the reduced format or not. Accordingly, if the O-RAN architecture 200 includes one or more O-RUs that do not support the channel estimate information in the reduced format, the transmission of the second capability indicator may enable the O-DU 402 to communicate, to the one or more O-RUs, the fourth C-plane message that indicates channel estimates for both the second set of active antennas and the second set of inactive antennas. Consequently, the transmission of the second capability indicator, specifying that the O-RU 404 supports the channel estimate information in the reduced format, may enable the O-DU 402 to communicate channel estimates without compromising on the network reliability.

FIG. 5 is a diagram that illustrates an example of the first C-plane message 316, in accordance with certain aspects of the present disclosure. FIG. 5 is explained in conjunction with FIG. 1-3. In numerous examples, the first C-plane message 316 may be transmitted from the O-DU 302 to the O-RU 304. In various examples, the first C-plane message 316 may be transmitted by the O-DU 302 to facilitate controlling of the antenna array 308.

As shown in FIG. 5, the first C-plane message 316 may include a transport header section 502, a common header 504, and section information 506. The transport header section 502 may include a header field that indicates the first C-plane message 316 as the ST6 message for channel information conveyance. The transport header section 502 may further include a transport header. The transport header may indicate information related to the first C-plane message 316, such as a message type, transmission source identifier(s), destination identifier(s), sequence number identifier(s), or the like. For example, the transport header may correspond to an enhanced Common Public Radio Interface (eCPRI) transport header or Institute of Electrical and Electronics Engineers (IEEE) transport header.

The common header 504 may include a dataDirection field, a payloadVersion field, a filterIndex (filter index) field, a frameId (frame identifier) field, a subframeId (subframe identifier) field, a slotID (slot identifier) field, a startSymbolid (start symbol identifier) field, a numberOfsections (number of sections) field, sectionType (section type) field with value=6, a numberOfUEs (number of UE-specific channel information data sets) field, and a reserved (reserved for future use) field.

The section information 506 may be configured for the UE 306. In various aspects, the section information 506 may optionally include ciCompHdr (channel information compression header) field. The ciCompHdr may hold metadata or header information related to a specific component in the first C-plane message 316. The section information 506 may further include an ef (extension flag) field, a ueId (UE identifier) field, a regularizationFactor (regularization factor used for MMSE) field, a reserved (reserved for future use) field, an rb (resource block identifier) field, a symInc (symbol number increment command) field, a startPrbc (starting PRB of data section description) field, and a numPrbc (number of contiguous PRBs per data section description) field. The section information 506 may optionally include ciCompParam (channel information compression parameter) field.

Referring to the example described in FIG. 3 where the first set of active antennas includes the first antenna, the second antenna, the sixth antenna, and the seventh antenna, the section information 506 may further include the first antenna identifier (denoted as 1^{st} antennaPortIndex) of the first antenna, a second antenna identifier (denoted as 2^{nd} antennaPortIndex) of the second antenna, a sixth antenna identifier (not shown) of the sixth antenna and a seventh antenna identifier (denoted as N^{th} antennaPortIndex) of the seventh antenna.

The section information 506 may further include the first set of channel estimates for the first set of active antennas. In reference to the example described in FIG. 3, the first set of channel estimates may include the first channel estimate for the first antenna, a second channel estimate for the second antenna, a sixth channel estimate for the sixth antenna, and a seventh channel estimate for the seventh antenna. Further, each channel estimate of the first set of channel estimates may include IQ data for each PRB of the first plurality of PRBs.

The first set of channel estimates associated with the first plurality of PRBs may be denoted as cilsample (first PRB, (antennaPortIndex+1)^{th} antenna) and ciQsample (first PRB, (antennaPortIndex+1)^{th} antenna), cilsample (first PRB, (antennaPortIndex+1)^{th} antenna) and ciQsample (first PRB, (antennaPortIndex+1)^{th} antenna), . . . , cilsample (first PRB, (antennaPortIndex+1)^{th} antenna) and ciQsample (first PRB, (antennaPortIndex+1)^{th} antenna), . . . , and cilsample (last PRB, (antennaPortIndex+1)^{th} antenna) and ciQsample (last PRB, (antennaPortIndex+1)^{th} antenna) in the section information 506.

In further aspects, the first C-plane message 316 may include the first format indicator 508 to specify whether the first C-plane message 316 includes the channel estimate information in the reduced format. The channel estimate information in the reduced format may exclusively indicate the first set of channel estimates for the first set of active antennas. In an example, the first format indicator 508 may correspond to the flag in the first C-plane message 316. The first format indicator 508 may indicate the first configured value (e.g., the Boolean value of ‘1’) to specify that the first C-plane message 316 includes the channel estimate information in the reduced format. Additionally, or alternatively, the first format indicator 508 may indicate the second configured value (e.g., the Boolean value of ‘0’) to specify that the first C-plane message 316 does not comprise the channel estimate information in the reduced format.

In some examples, the first format indicator 508 in the first C-plane message 316 may further indicate that in the first C-plane message 316, each channel estimate of the first set of channel estimates is associated with the antenna identifier of the corresponding active antenna of the first set of active antennas. That is to say, the first format indicator 508 may indicate the first configured value (e.g., the Boolean value of ‘1’) to indicate that each channel estimate of the first set of channel estimates is associated with the antenna identifier of the corresponding active antenna of the first set of active antennas. In various aspects, a format of the second C-plane message 320 may be similar to a format of the first C-plane message 316 described in FIG. 5.

FIG. 6 is a diagram that illustrates an example of the first C-plane message 418, in accordance with certain aspects of the present disclosure. FIG. 6 is explained in conjunction with FIGS. 1, 2, and 4. In numerous examples, the first C-plane message 418 may be transmitted from the O-DU 402 to the O-RU 404. In various examples, the first C-plane message 418 may be transmitted by the O-DU 302 to enable control of the antenna array 408.

As shown in FIG. 6, the first C-plane message 418 may include a transport header section 602, a common header 604, and section information 606. The transport header section 602 may be similar to the transport header section 502. Further, the common header 604 may be similar to the common header 504.

The section information 606 may be configured for the UE 406. In various aspects, the section information 606 may optionally include ciCompHdr (channel information compression header) field. The ciCompHdr may hold metadata or header information related to a specific component in the first C-plane message 418. The section information 606 may further include an ef (extension flag) field, a ueId (UE identifier) field, a regularizationFactor (regularization factor used for MMSE) field, a reserved (reserved for future use) field, an rb (resource block identifier) field, a symInc (symbol number increment command) field, a startPrbc (starting PRB of data section description) field, and a numPrbc (number of contiguous PRBs per data section description) field. The section information 606 may optionally include ciCompParam (channel information compression parameter) field.

In numerous aspects, the first C-plane message 418 may include the second format indicator 608 to specify whether the first C-plane message 418 includes the channel estimate information in the reduced format. The channel estimate information in the reduced format may exclusively indicate the third set of channel estimates for the second set of active antennas. In an example, the second format indicator 608 may correspond to the flag in the first C-plane message 418. The first C-plane message 418 may indicate the third configured value (e.g., the Boolean value of ‘1’) to specify that the first C-plane message 418 includes the channel estimate information in the reduced format. Additionally, or alternatively, the second format indicator 608 may indicate the fourth configured value (e.g., the Boolean value of ‘0’) to specify that the first C-plane message 418 does not comprise the channel estimate information in the reduced format. In some examples, the second format indicator 608 may further specify that the third set of channel estimates is in a same sequence as the second set of active antennas in the third C-plane message 414.

In various aspects, the section information 606 may include the third set of channel estimates 610 for the second set of active antennas. Each channel estimate of the third set of channel estimates 610 may include IQ data for each PRB of the second plurality of PRBs.

The third set of channel estimates 610 associated with the second plurality of PRBs may be denoted as cilsample (first PRB, (switched on antenna 1^{st} antenna) and ciQsample (first PRB, (switched on antenna 1^{st} antenna), cilsample (first PRB, (switched on antenna 2^{nd} antenna) and ciQsample (first PRB, (switched on antenna 2^{nd} antenna), . . . , cilsample (first PRB, switched on antenna N^{th} antenna) and ciQsample (first PRB, switched on antenna N^{th} antenna), . . . , and cilsample (last PRB, (switched on antenna N^{th} antenna) and ciQsample (last PRB, (switched on antenna N^{th} antenna) in the section information 606.

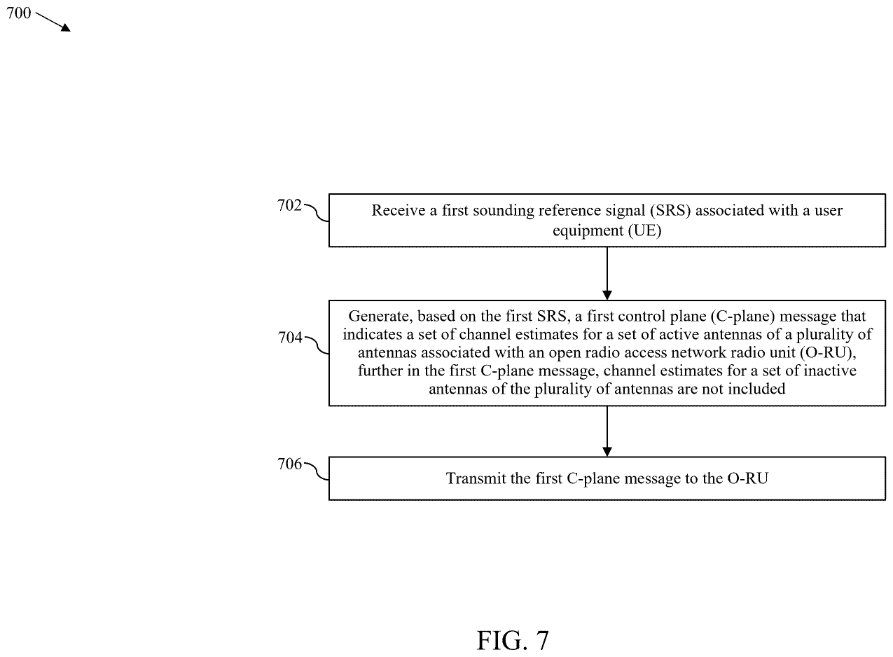

FIG. 7 is a diagram that illustrates a high-level flowchart for a process (e.g., a method) 700 for wireless communication, in accordance with certain aspects of the present disclosure. FIG. 7 is explained in conjunction with FIG. 1-6. In various examples, the process 700 may be implemented by an O-DU to facilitate wireless communication. The O-DU in FIG. 7 may correspond to any of the DU 114, the O-DU 206, the O-DU 302, or the O-DU 402. Further, a UE described in FIG. 7 may correspond to any of the UE 106, UE 210, UE 306, or the UE 406. An O-RU described in FIG. 7 may correspond to any one of the RU 116, the O-RU 208, the O-RU 304, or the O-RU 404.

At 702, the O-DU may receive a first SRS (for example, the first SRS 314 or the first SRS 416) associated with the UE from the O-RU. In some aspects, the first SRS may be transmitted by the UE to the O-RU. Further, the O-RU may transmit the first SRS to the O-DU. The first SRS may indicate characteristics of a communication channel between the UE and a base station (for example, the O-DU, the O-RU, or a combination of the O-DU and the O-RU).

At 704, the O-DU may generate a first C-plane message (for example, the first C-plane message 316 or the first C-plane message 418) based on the first SRS. The first C-plane message may indicate a set of channel estimates (for example, the first set of channel estimates or the third set of channel estimates) for a set of active antennas (for example, the first set of active antennas or the second set of active antennas) of a plurality of antennas (for example, the plurality of antennas 310 or the plurality of antennas 410) associated with the O-RU. Further, the first C-plane message may not include channel estimates for a set of inactive antennas (for example, the first set of inactive antennas or the second set of inactive antennas) of the plurality of antennas. In some examples, the first C-plane message may correspond to the ST6 message.

At 706, the O-DU may transmit the first C-plane message to the O-RU. In numerous examples, the first C-plane message may be transmitted via the fronthaul interface.

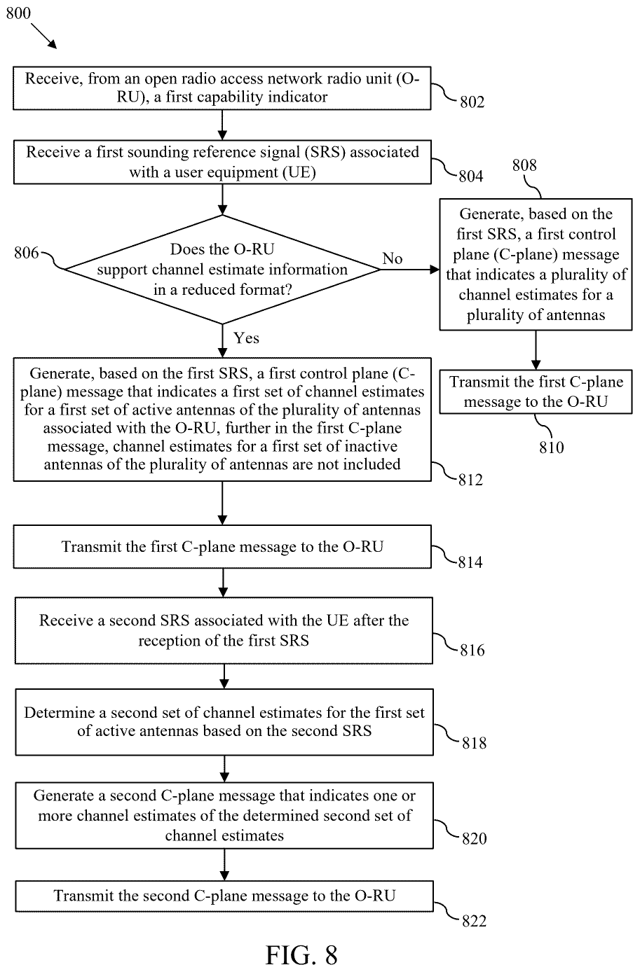

FIG. 8 is a diagram that illustrates a flowchart for a process (e.g., a method) 800 for the wireless communication, in accordance with certain aspects of the present disclosure. FIG. 8 is explained in conjunction with FIGS. 1, 2, 3, and 5. In various examples, the process 800 may be implemented by the DU 114, the O-DU 206, or the O-DU 302 to communicate wirelessly with a communication device (e.g., the UE 306).

At 802, the O-DU 302 may receive the first capability indicator from the O-RU 304. In various examples, the first capability indicator may be received via the M-plane message 312. In some more examples, the first capability indicator may correspond to the flag in the M-plane message 312. For example, the first capability indicator may indicate the first configured value (e.g., the Boolean value of ‘1’) to specify that the O-RU 304 supports the channel estimate information for the plurality of antennas 310 in the reduced format. Additionally, or alternatively, the first capability indicator may indicate the second configured value (e.g., the Boolean value of ‘0’) to specify that the O-RU 304 does not support the channel estimate information for the plurality of antennas 310 in the reduced format.

At 804, the O-DU 302 may receive the first SRS 314 associated with the UE 306 from the O-RU 304. In further aspects, the O-RU 304 may receive the first SRS 314 from the UE 306 and may transmit the first SRS 314 to the O-DU 302. The first SRS 314 may indicate the characteristics of the channel between the UE 306 and the base station (for example, the O-DU 302, the O-RU 304, or the combination of the O-DU 302 and the O-RU 304) at the first time instance.

At 806, a determination of whether the O-RU 304 supports the channel estimate information in the reduced format may be performed. In numerous examples, the O-DU 302 may perform the determination based on the first capability indicator of the M-plane message 312. In further examples, the determination may be performed by the O-DU 302 based on the reception of the first SRS 314.

In some aspects, if the O-DU 302 determines that the O-RU 304 does not support the channel estimate information in the reduced format, the O-DU 302 may generate a first C-plane message that indicates a plurality of channel estimates for the plurality of antennas 310 based on the first SRS 314 at 808. At 810, the O-DU 302 may transmit the first C-plane message generated at 808 to the O-RU 304. The first C-plane message may correspond to the ST6 message.

In further aspects, if the O-DU 302 determines that the O-RU 304 supports the channel estimate information in the reduced format, the O-DU 302 may generate the first C-plane message 316 based on the first SRS 314 at 812. The first C-plane message 316 may indicate the first set of channel estimates for the first set of active antennas of the plurality of antennas 310 associated with the O-RU 304. Further, the first C-plane message 316 may not include the channel estimates for the first set of inactive antennas of the plurality of antennas 310. In numerous examples, the first C-plane message 316 may correspond to the ST6 message.

In some aspects, in the first C-plane message 316, each channel estimate of the first set of channel estimates may be associated with the antenna identifier of the corresponding active antenna of the first set of active antennas. For example, in the first C-plane message 316, an indication that a channel estimate of the first set of channel estimates corresponds to an active antenna of the first set of active antennas may be provided by way of an antenna identifier of the active antenna.

At 814, the O-DU 302 may transmit the first C-plane message 316 to the O-RU 304. In numerous examples, the first C-plane message 316 may be transmitted via the fronthaul interface.

At 816, the O-DU 302 may receive the second SRS 318 associated with the UE 306 after the reception of the first SRS 314. The second SRS 318 may indicate the characteristics of the channel between the UE 306 and the base station (for example, the O-DU 302, the O-RU 304, or the combination of the O-DU 302 and the O-RU 304) at the second time instance.

At 818, the O-DU 302 may determine the second set of channel estimates for the first set of active antennas based on the second SRS 318. At 820, the O-DU 302 may generate the second C-plane message 320 that indicates the one or more channel estimates of the determined second set of channel estimates. The one or more channel estimates of the determined second set of channel estimates may deviate from corresponding one or more channel estimates of the first set of channel estimates. Additionally, the second C-plane message 320 may not include at least one channel estimate of the second set of channel estimates that is same as a corresponding channel estimate of the first set of channel estimates. In numerous examples, the second C-plane message 320 may correspond to the ST6 message.

At 822, the O-DU 302 may transmit the second C-plane message 320 to the O-RU 304. In numerous examples, the second C-plane message 320 may be transmitted via the fronthaul interface. The O-RU 304 may control the plurality of antennas 310 based on the second C-plane message 320 to communicate with the UE 306.

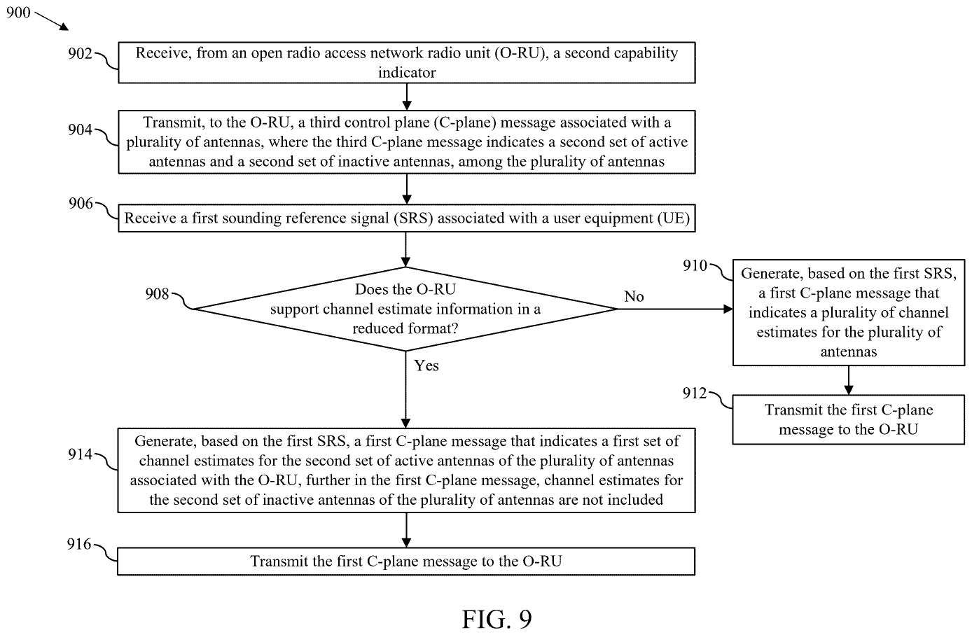

FIG. 9 is a diagram that illustrates a flowchart for a process (e.g., a method) 900 for the wireless communication, in accordance with certain aspects of the present disclosure. FIG. 9 is explained in conjunction with FIGS. 1, 2, 4, and 6. In various examples, the process 900 may be implemented by the O-DU 402.

At 902, the O-DU 402 may receive the second capability indicator from the O-RU 404. In various examples, the second capability indicator may be received via the M-plane message 412. In some more examples, the second capability indicator may correspond to the flag in the M-plane message 412. For example, the second capability indicator may indicate the third configured value (e.g., the Boolean value of ‘1’) to specify that the O-RU 404 supports the channel estimate information for the plurality of antennas 410 in the reduced format. Additionally, or alternatively, the second capability indicator may indicate the fourth configured value (e.g., the Boolean value of ‘0’) to specify that the O-RU 404 does not support the channel estimate information for the plurality of antennas 410 in the reduced format.

At 904, the O-DU 402 may transmit the third C-plane message 414 associated with the plurality of antennas 410 to the O-RU 404. The third C-plane message 414 may indicate the second set of active antennas and the second set of inactive antennas, among the plurality of antennas 410. In some examples, the third C-plane message 414 may be generated by the O-DU 402 prior to the transmission of the third C-plane message 414 to the O-RU 404. In an example, the third C-plane message 414 may correspond to the ST4 message utilized for configuring or managing the wireless communication.

In some aspects, to generate the third C-plane message 414, the bitmap for the plurality of antennas 410 may be generated by the O-DU 402. In some examples, the bitmap may include the plurality of bits for the plurality of antennas 410, respectively. Thus, each bit of the plurality of bits may be mapped to a corresponding antenna of the plurality of antennas 410.

At 906, the O-DU 402 may receive the first SRS 416 associated with the UE 406 from the O-RU 304. In further aspects, the O-RU 404 may receive the first SRS 416 from the UE 406 and may transmit the first SRS 416 to the O-DU 402. The first SRS 416 may indicate the characteristics of the channel between the UE 406 and the base station (for example, the O-DU 402, the O-RU 404, or the combination of the O-DU 402 and the O-RU 404).

At 908, a determination of whether the O-RU 404 supports the channel estimate information in the reduced format may be performed by the O-DU 402. In numerous examples, the O-DU 402 may perform the determination based on the second capability indicator of the M-plane message 412. In further examples, the determination may be performed by the O-DU 402 upon the reception of the first SRS 416.

In some aspects, if the O-DU 402 determines that the O-RU 404 does not support the channel estimate information in the reduced format, the O-DU 402 may generate a first C-plane message that indicates a plurality of channel estimates for the plurality of antennas 410 based on the first SRS 416 at 910. At 912, the O-DU 402 may transmit the first C-plane message generated at 910 to the O-RU 404. The first C-plane message may correspond to the ST6 message.

In further aspects, if the O-DU 402 determines that the O-RU 404 supports the channel estimate information in the reduced format, at 914, the O-DU 402 may generate the first C-plane message 418 based on the first SRS 416. The first C-plane message 418 may indicate the third set of channel estimates for the second set of active antennas of the plurality of antennas 410. Further, the first C-plane message 418 may not include channel estimates for the second set of inactive antennas of the plurality of antennas 410. In numerous examples, the first C-plane message 418 may correspond to the ST6 message.

In some examples, in the first C-plane message 418, the third set of channel estimates for the second set of active antennas may be indicated in the same sequence in which the second set of active antennas is indicated in the bitmap of the third C-plane message 414.

In various aspects, the first C-plane message 418 may include the second format indicator 608 that may specify that the first C-plane message 418 includes the channel estimate information for the plurality of antennas 410 in the reduced format. In some examples, the channel estimate information in the reduced format may exclusively indicate the third set of channel estimates for the second set of active antennas. In further aspects, the second format indicator 608 may further specify that the third set of channel estimates is in the same sequence as the second set of active antennas in the third C-plane message 414.

At 916, the O-DU 402 may transmit the first C-plane message 418 to the O-RU 404. In numerous examples, the first C-plane message 418 may be transmitted via the fronthaul interface.

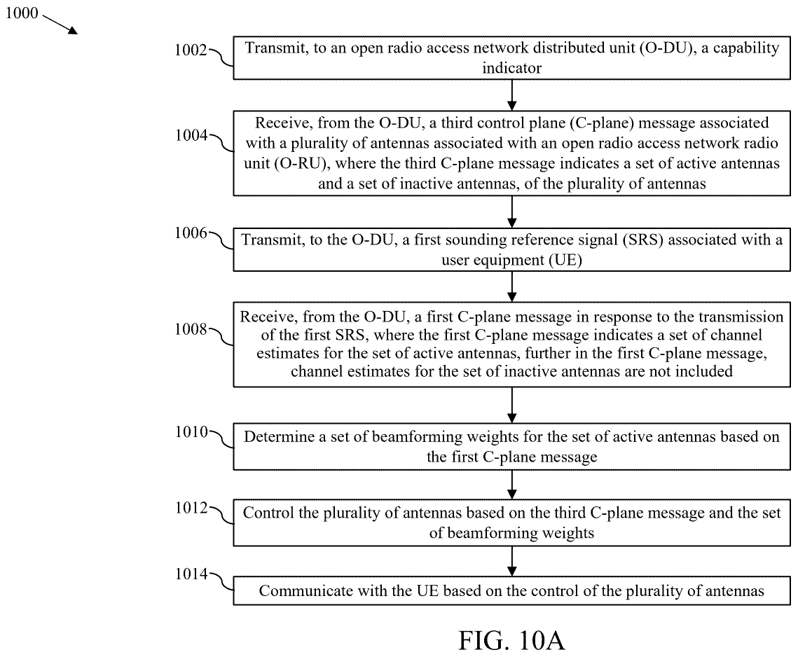

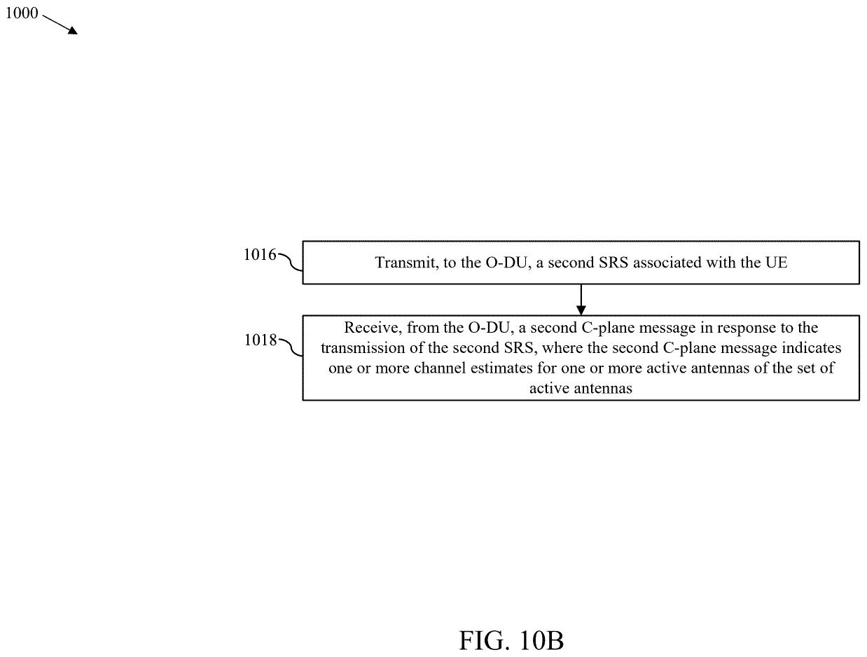

FIGS. 10A and 10B, collectively, illustrate a flowchart for a process (e.g., a method) 1000 for the wireless communication, in accordance with certain aspects of the present disclosure. FIGS. 10A and 10B are explained in conjunction with FIG. 1-6. In various examples, the process 1000 may be implemented by an O-RU. The O-RU described in FIGS. 10A and 10B may correspond to at least one of the RU 116, the O-RU 208, the O-RU 304, or the O-RU 404. Further, an O-DU described in FIGS. 10A and 10B may correspond to the DU 114, the O-DU 206, the O-DU 302, or the O-DU 402.

Referring to FIG. 10A, at 1002, the O-RU may transmit a capability indicator (for example, the first capability indicator or the second capability indicator) to the O-DU. In various examples, the capability indicator may be transmitted via an M-plane message (for example, the M-plane message 312 or the M-plane message 412). In some examples, the capability indicator may specify whether the O-RU supports channel estimate information associated with a plurality of antennas in a reduced format. In FIGS. 10A and 10B, the plurality of antennas may correspond to at least one of the plurality of antennas 310 or the plurality of antennas 410.

At 1004, the O-RU may receive a third C-plane message (for example, the third C-plane message 414) associated with the plurality of antennas associated with the O-RU from the O-DU. The third C-plane message may indicate a set of active antennas (for example, the first set of active antennas or the second set of active antennas) and a set of inactive antennas (for example, the second set of active antennas and the second set of inactive antennas) of the plurality of antennas.

At 1006, the O-RU may transmit a first SRS (for example, the first SRS 314 or the first SRS 416) associated with a UE (for example, the UE 106, the UE 210, the UE 306, or the UE 406) to the O-DU. The first SRS may indicate characteristics of a channel between the UE and a base station (for example, the O-DU, the O-RU, or the combination of the O-DU and the O-RU) at the first time instance.

At 1008, the O-RU may receive a first C-plane message (for example, the first C-plane message 316 or the first C-plane message 418) from the O-DU. The first C-plane message may indicate a set of channel estimates (for example, the first set of channel estimates or the third set of channel estimates) for the set of active antennas. Further, the first C-plane message may not include channel estimates for the set of inactive antennas.

At 1010, the O-RU may determine a set of beamforming weights (for example, the first set of beamforming weights or the second set of beamforming weights) for the set of active antennas based on the first C-plane message. In various examples, each beamforming weight of the set of beamforming weights may represent a set of complex coefficient values, defined by I (in-phase) and Q (quadrature) components, utilized to control the amplitude, the phase, or a combination thereof of the wireless signal associated with the respective antenna of the set of active antennas.

At 1012, the O-RU may control the plurality of antennas based on the set of beamforming weights and the third C-plane message. In various examples, the control of the plurality of antennas may include configuring (or assigning) the set of active antennas of the plurality of antennas with the set of beamforming weights.

At 1014, the O-RU may communicate with the UE based on the control of the plurality of antennas. In various examples, the communication with the UE may be via the set of active antennas of the plurality of antennas. In an example, the data intended for the UE may be communicated via one or more beams formed by the set of active antennas.

Referring to FIG. 10B, at 1016, the O-RU may transmit a second SRS (for example, the second SRS 318) associated with the UE to the O-DU. The second SRS may indicate the characteristics of the channel between the UE and the base station at the second time instance.

At 1018, the O-RU may receive a second C-plane message (for example, the second C-plane message 320) from the O-DU in response to the transmission of the second SRS. The second C-plane message may indicate one or more channel estimates for one or more active antennas for the set of active antennas. The one or more channel estimates may deviate from corresponding one or more channel estimates of the first set of channel estimates. The second C-plane message may not include at least one channel estimate of at least one active antenna of the set of active antennas.

In some aspects, operations 1016 and 1018 may be optional in the process 1000. In some more aspects, operation 1004 may be optional in the process 1000.

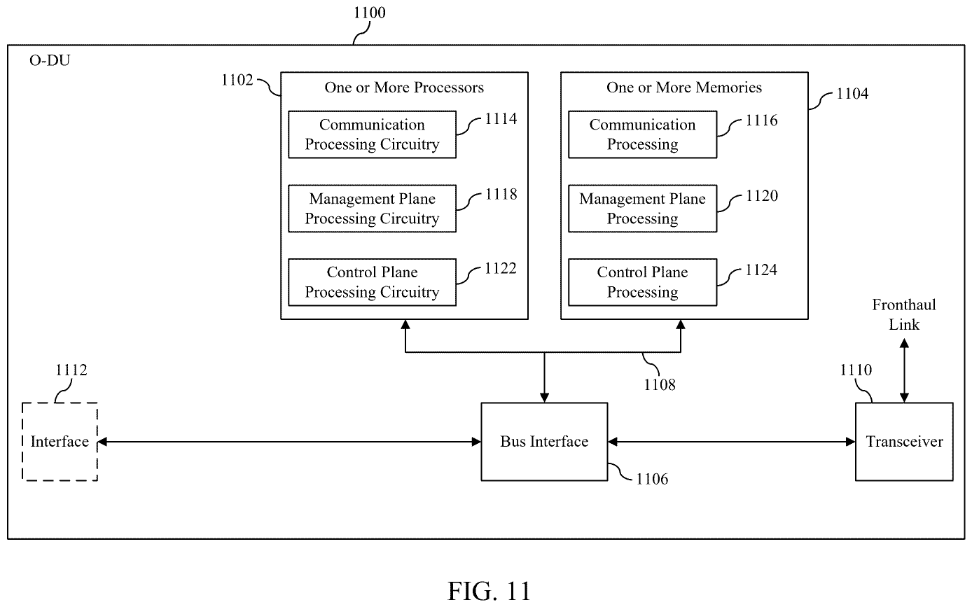

FIG. 11 is a diagram that illustrates an example of an O-DU 1100, in accordance with certain aspects of the present disclosure. FIG. 11 is explained in conjunction with FIG. 1-10. The O-DU 1100 may facilitate wireless communication with an O-RU, one or more communication devices, or a combination thereof. In some examples, the O-DU 1100 may correspond to the NR base station, the LTE base station, the eNB, the gNB, the access point, the TRP, or the like.

In some aspects, the O-DU 1100 may include one or more processors 1102, one or more memories 1104, a bus interface 1106, a bus 1108, and a transceiver 1110. Examples of the one or more processors 1102 may include microprocessors, microcontrollers, digital signal processors (DSPs), field programmable gate arrays (FPGAs), programmable logic devices (PLDs), state machines, gated logic, discrete hardware circuits, or suitable hardware configured to perform the various functionality described throughout this disclosure. In various examples, the O-DU 1100 may be configured to perform one or more of the functions described in FIG. 1-10. That is, the one or more processors 1102, as utilized in the O-DU 1100, may be used to implement one or more of the processes and procedures described in FIG. 1-10.

The one or more processors 1102 may in some instances be implemented via a baseband or modem chip and in additional implementations, the one or more processors 1102 may comprise a number of devices distinct and different from a baseband or modem chip. And as mentioned above, various hardware arrangements and components outside of a baseband modem processor can be used in implementations, including RF-chains, power amplifiers, modulators, buffers, interleavers, adders/summers, etc.

In various aspects, the one or more processors 1102 may be configured to receive an SRS associated with a UE. Further, the one or more processors 1102 may be configured to generate a C-plane message based on the SRS. The C-plane message may indicate a first set of channel estimates for a set of active antennas of a plurality of antennas associated with an O-RU. Also, the C-plane message may not include channel estimates for a set of inactive antennas of the plurality of antennas. The one or more processors 1102 may be further configured to transmit the C-plane message to the O-RU.

The one or more memories 1104 may include suitable circuitry, interfaces, or logic configured to store instructions (e.g., computer-executable code) that when executed by the one or more processors 1102 may cause the one or more processors 1102 to perform the operations illustrated in FIG. 1-10, or additional operations to optimize channel information signaling in fronthaul interface. The O-DU 1100 may store data within the one or more memories 1104 by transforming the physical state of one or more physical storage units (e.g., transistors, magnetic domains, optical pits, gate cells, phase change materials, etc.) in the one or more memories 1104 to reflect the information being stored. The specific transformation of physical state can depend on various factors. Examples of such factors can include, but are not limited to, the technology used to implement the physical storage units, whether the one or more memories 1104 is characterized as primary or secondary storage, and the like.

In further aspects, the one or more memories 1104 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing software or instructions that may be accessed and read by a computer.

In numerous examples, the O-DU 1100 may be implemented with a bus architecture, represented generally by the bus 1108. The bus 1108 may include one or more interconnecting buses or bridges based on the specific application of the O-DU 1100 and the overall design constraints. The bus 1108 may communicatively couple various circuits including the one or more processors 1102, the one or more memories 1104, and the bus interface 1106. In some examples, bus 1108 may also link various circuits such as timing sources, peripherals, voltage regulators, and power management circuits, that are well known in the art, and therefore, will not be described any further.

In some aspects, the bus interface 1106 may provide an interface between the bus 1108 and the transceiver 1110. In some more aspects, the O-DU 1100 may further include an interface 1112. The transceiver 1110 may provide a communication interface or means for communicating with various apparatus over a wireless transmission medium. In some additional examples, the O-DU 1100 may include two or more transceivers, each configured to communicate with a respective network type (e.g., terrestrial or non-terrestrial). The interface 1112 may provide a communication interface or means of communicating with various apparatuses and devices (e.g., devices housed within the same apparatus as the O-DU 1100 or external apparatuses) over an internal bus or external transmission medium, such as an Ethernet cable. Depending upon the nature of the apparatus, the interface 1112 may optionally include a user interface.

The one or more processors 1102 may be responsible for managing the bus 1108 and general processing, including the execution of software stored on the one or more memories 1104. The software, when executed by the one or more processors 1102, may cause the one or more processors 1102 to perform the various functions described in FIG. 1-10. In some examples, the one or more memories 1104 may be used for storing data that is manipulated by the one or more processors 1102 when executing the software.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 1102, may include circuitry configured for various functions. The one or more processors 1102 may include communication processing circuitry 1114. The communication processing circuitry 1114 may be configured to communicate with an O-RU (for example, the RU 116, the O-RU 208, the O-RU 304, or the O-RU 404) via the transceiver 1110 and a fronthaul link.

In various aspects, the communication processing circuitry 1114 may obtain information from a component of the O-DU 1100 (for example, from the transceiver 1110 that receives the information via radio frequency signaling or some type of signaling suitable for the applicable communication medium), process (for example, decode) the information, and output the processed information. For example, the communication processing circuitry 1114 may output the information to a different component of the one or more processors 1102, to the one or more memories 1104, or to the bus interface 1106. In some examples, the communication processing circuitry 1114 may receive one or more of signals, messages, information, or any combination thereof. In some examples, the communication processing circuitry 1114 may receive information via one or more channels. In some examples, the communication processing circuitry 1114 may include functionality for a means for receiving.

In some aspects, the communication processing circuitry 1114 may obtain information (for example, from a different component of the one or more processors 1102, the one or more memories 1104, or the bus interface 1106), process (for example, encode) the information, and output the processed information. For example, the communication processing circuitry 1114 may output the information to the transceiver 1110. In some examples, the communication processing circuitry 1114 may transmit information via one or more channels. In some examples, the communication processing circuitry 1114 may include functionality for a means for transmitting. In various examples, the communication processing circuitry 1114 may further be configured to execute communication processing software 1116 included on the one or more memories 1104 to implement one or more functions described herein.

In numerous additional aspects, the one or more processors 1102 may include management plane processing circuitry 1118 configured to perform management plane processing-related operations as discussed herein (for example, receiving an M-plane message from an O-RU and processing the M-plane message to determine capabilities of the O-RU). The management plane processing circuitry 1118 may further be configured to execute management plane processing software 1120 included on the one or more memories 1104 to implement one or more functions described herein.

In various aspects, the one or more processors 1102 may include control plane processing circuitry 1122 configured to perform control plane processing-related operations as discussed herein (for example, generating C-plane messages, transmitting the C-plane messages to the O-RU, or the like). The control plane processing circuitry 1122 may further be configured to execute control plane processing software 1124 included on the one or more memories 1104 to implement one or more functions described herein.

In some implementations, the O-DU 1100 may be configured to operate as the DU 114, the O-DU 206, the O-DU 302, or the O-DU 402 described herein. In some more implementations, the DU 114, the O-DU 206, the O-DU 302, or the O-DU 402 described herein may correspond to (or may be included in) the O-DU 1100. For example, the one or more processors 1102 or any remaining components of the O-DU 1100 may enable the O-DU 1100 to perform the operations of one or more processes (for example, the processes 700-900) described herein.

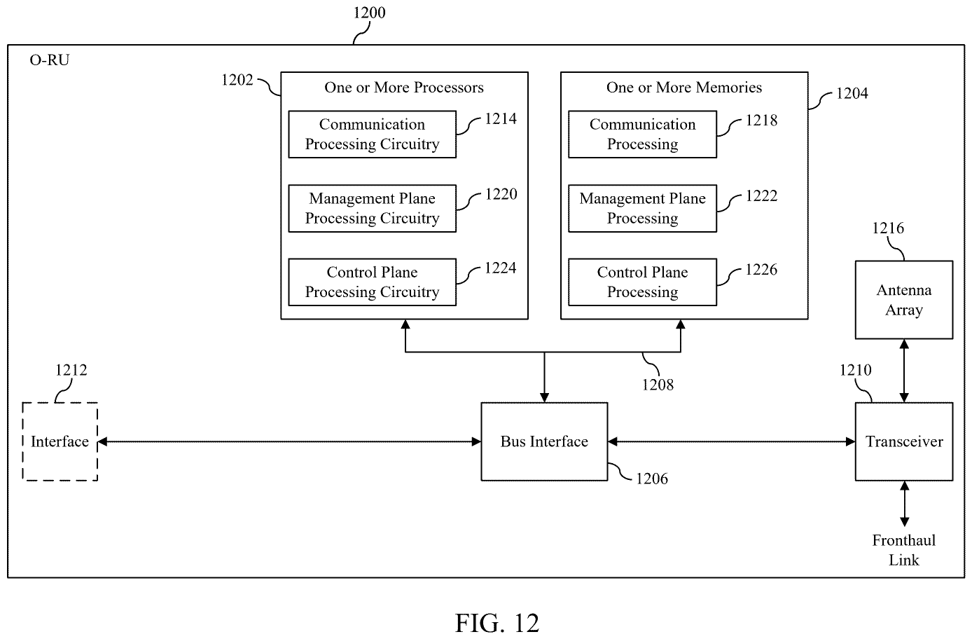

FIG. 12 is a diagram that illustrates an example of an O-RU 1200, in accordance with certain aspects of the present disclosure. FIG. 12 is explained in conjunction with FIG. 1-10. The O-RU 1200 may facilitate wireless communication with an O-DU, one or more communication devices (for example, UEs), or a combination thereof. In some examples, the O-RU 1200 may correspond to the NR base station, the LTE base station, the eNB, the gNB, the access point, the TRP, or the like.

In some aspects, the O-RU 1200 may include one or more processors 1202, one or more memories 1204, a bus interface 1206, a bus 1208, and a transceiver 1210. Examples of the one or more processors 1202 may include microprocessors, microcontrollers, DSPs, FPGAs, PLDs, state machines, gated logic, discrete hardware circuits, and suitable hardware configured to perform the various functionalities described throughout this disclosure. In various examples, the O-RU 1200 may be configured to perform one or more of the functions described in FIG. 1-10. That is, the one or more processors 1202, as utilized in the O-RU 1200, may be used to implement one or more of the processes and procedures described in FIG. 1-10.

The one or more processors 1202 may in some instances be implemented via a baseband or modem chip and in additional implementations, the one or more processors 1202 may itself comprise a number of devices distinct and different from a baseband or modem chip (e.g., in such scenarios as may work in concert to achieve embodiments discussed herein). And as mentioned above, various hardware arrangements and components outside of a baseband modem processor can be used in implementations, including RF-chains, power amplifiers, modulators, buffers, interleavers, adders/summers, etc.

The one or more memories 1204 may include suitable circuitry, interfaces, or logic configured to store instructions (e.g., computer-executable code) that when executed by the one or more processors 1202 may cause the one or more processors 1202 to perform the operations illustrated in FIG. 1-10, or additional operations to optimize channel information signaling in fronthaul interface. The O-RU 1200 may store data within the one or more memories 1204 by transforming the physical state of one or more physical storage units (e.g., transistors, magnetic domains, optical pits, gate cells, phase change materials, etc.) in the one or more memories 1204 to reflect the information being stored. The specific transformation of physical state can depend on various factors. Examples of such factors can include, but are not limited to, the technology used to implement the physical storage units, whether the one or more memories 1204 are characterized as primary or secondary storage, and the like.

In further aspects, the one or more memories 1204 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing software or instructions that may be accessed and read by a computer.

In numerous examples, the O-RU 1200 may be implemented with a bus architecture, represented generally by the bus 1208. The bus 1208 may include one or more interconnecting buses or bridges based on the specific application of the O-RU 1200 and the overall design constraints. The bus 1208 may communicatively couple various circuits including the one or more processors 1202, the one or more memories 1204, and the bus interface 1206. In some examples, bus 1208 may also link various circuits such as timing sources, peripherals, voltage regulators, and power management circuits, that are well known in the art, and therefore, will not be described any further.

In some aspects, the bus interface 1206 may provide an interface between the bus 1208 and the transceiver 1210. In some more aspects, the O-RU 1200 may further include an interface 1212. The transceiver 1210 may provide a communication interface or means for communicating with various apparatus over a wireless transmission medium. In some additional examples, the O-RU 1200 may include two or more transceivers, each configured to communicate with a respective network type (e.g., terrestrial or non-terrestrial). The interface 1212 may provide a communication interface or means of communicating with various apparatuses and devices (e.g., devices housed within the same apparatus as the O-RU 1200 or external apparatuses) over an internal bus or external transmission medium, such as an Ethernet cable. Depending upon the nature of the apparatus, the interface 1212 may optionally include a user interface.

The one or more processors 1202 may be responsible for managing the bus 1208 and general processing, including the execution of software stored on the one or more memories 1204. The software, when executed by the one or more processors 1202, may cause the one or more processors 1202 to perform the various functions described in FIG. 1-10. In some examples, the one or more memories 1204 may be used for storing data that is manipulated by the one or more processors 1202 when executing the software.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 1202, may include circuitry configured for various functions. The one or more processors 1202 may include communication processing circuitry 1214. In some examples, the communication processing circuitry 1214 may be configured to communicate with a UE (for example, the UE 106, UE 210, the UE 306, or the UE 406) via the transceiver 1210 and an antenna array 1216. In some more examples, the communication processing circuitry 1214 may be configured to communicate with an O-DU (for example, the DU 114, the O-DU 206, the O-DU 302, or the O-DU 402) via the transceiver 1210 and a fronthaul link.

In various aspects, the communication processing circuitry 1214 may obtain information from a component of the O-RU 1200 (for example, from the transceiver 1210 that receives the information via radio frequency signaling or some type of signaling suitable for the applicable communication medium), process (for example, decode) the information, and output the processed information. For example, the communication processing circuitry 1214 may output the information to a different component of the one or more processors 1202, to the one or more memories 1204, or to the bus interface 1206. In some examples, the communication processing circuitry 1214 may receive one or more of signals, messages, information, or any combination thereof. In some examples, the communication processing circuitry 1214 may receive information via one or more channels. In some examples, the communication processing circuitry 1214 may include functionality for a means for receiving.

In some aspects, the communication processing circuitry 1214 may obtain information (for example, from a different component of the one or more processors 1202, the one or more memories 1204, or the bus interface 1206), process (for example, encode) the information, and output the processed information. For example, the communication processing circuitry 1214 may output the information to the transceiver 1210. In some examples, the communication processing circuitry 1214 may transmit information via one or more channels. In some examples, the communication processing circuitry 1214 may include functionality for a means for transmitting. In various examples, the communication processing circuitry 1214 may further be configured to execute communication processing software 1218 included on the one or more memories 1204 to implement one or more functions described herein.

In numerous additional aspects, the one or more processors 1202 may include management plane processing circuitry 1220 configured to perform management plane processing-related operations as discussed herein (for example, generating an M-plane message). The management plane processing circuitry 1220 may further be configured to execute management plane processing software 1222 included on the one or more memories 1204 to implement one or more functions described herein.

In various aspects, the one or more processors 1202 may include control plane processing circuitry 1224 configured to perform control plane processing-related operations as discussed herein (for example, receiving C-plane messages, processing the C-plane messages, or the like). The control plane processing circuitry 1224 may further be configured to execute control plane processing software 1226 included on the one or more memories 1204 to implement one or more functions described herein.

In some implementations, the O-RU 1200 may be configured to operate as the RU 116, the O-RU 208, the O-RU 304, or the O-RU 404 described herein. In some more implementations, RU 116, the O-RU 208, the O-RU 304, or the O-RU 404 described herein may correspond to (or may be included in) the O-RU 1200. For example, the one or more processors 1202 or any remaining components of the O-RU 1200 may enable the O-RU 1200 to perform the operations of one or more processes (for example, the process 1000) described herein.

Some implementation examples are described in the following numbered aspects:
Aspect 1: A method for optimization of channel information signaling in fronthaul interface, comprising: in an Open-Radio Access Network (O-RAN) Distributed Unit (O-DU): receiving a first sounding reference signal associated with a user equipment (UE); generating, based on the first SRS, a first control plane (C-plane) message that indicates a first set of channel estimates for a set of active antennas of a plurality of antennas associated with an O-RAN Radio Unit (O-RU), wherein the first C-plane message does not include channel estimates for a set of inactive antennas of the plurality of antennas; and transmitting the first C-plane message to the O-RU.
Aspect 2: The method of aspect 1, wherein the first C-plane message comprises a format indicator to specify that the first C-plane message comprises channel estimate information in a reduced format, and the channel estimate information in the reduced format exclusively indicates the first set of channel estimates for the set of active antennas.
Aspect 3: The method of any of aspects 1 and 2, further comprising, receiving, from the O-RU, a capability indicator specifying that the O-RU supports the channel estimate information in the reduced format.
Aspect 4: The method of aspect 3, wherein the reception of the capability indicator is via a management plane (M-plane) message, and the capability indicator is received prior to the reception of the first SRS.
Aspect 5: The method of any of aspects 1 through 4, wherein in the first C-plane message, each channel estimate of the first set of channel estimates is associated with an antenna identifier of a corresponding active antenna of the set of active antennas.
Aspect 6: The method of any of aspects 1 through 5, further comprising: receiving a second SRS associated with the UE after the reception of the first SRS; determining a second set of channel estimates for the set of active antennas based on the second SRS; generating a second C-plane message that indicates one or more channel estimates of the determined second set of channel estimates, wherein the one or more channel estimates of the determined second set of channel estimates deviate from corresponding one or more channel estimates of the first set of channel estimates, and the second C-plane message does not include at least one channel estimate of the second set of channel estimates that is same as a corresponding channel estimate of the first set of channel estimates; and transmitting the second C-plane message to the O-RU.
Aspect 7: The method of any of aspects 1 through 6, wherein the first C-plane message corresponds to a Section Type 6 (ST6) message.
Aspect 8: The method of any of aspects 1 through 7, wherein the set of active antennas corresponds to one or more first antennas among the plurality of antennas that are switched ON, and the set of inactive antennas corresponds to one or more second antennas among the plurality of antennas that are switched OFF.
Aspect 9: The method of any of aspects 1 through 7, further comprising: transmitting, to the O-RU, a third C-plane message associated with the plurality of antennas prior to the transmission of the first C-plane message, wherein the third C-plane message indicates the set of active antennas and the set of inactive antennas.
Aspect 10: The method of aspect 9, wherein the third C-plane message comprises a bitmap having a plurality of bits, each bit of the plurality of bits is mapped to a corresponding antenna of the plurality of antennas, and each bit of the plurality of bits has one of a first value indicating that the corresponding antenna is active, or a second value indicating that the corresponding antenna is inactive.
Aspect 11: The method of aspect 10, wherein in the first C-plane message, the first set of channel estimates for the set of active antennas is indicated in a same sequence in which the set of active antennas is indicated in the bitmap of the third C-plane message.
Aspect 12: The method of any of aspects 1 through 11, wherein each channel estimate of the first set of channel estimates is associated with a plurality of physical resource blocks associated with the UE.
Aspect 13: A method for optimization of channel information signaling in fronthaul interface, comprising: in an Open-Radio Access Network (O-RAN) Radio Unit (O-RU): transmitting, to an O-RAN Distributed Unit (ODU), a first sounding reference signal associated with a user equipment (UE); and receiving, from the O-DU, a first control plane (C-plane) message associated with the user equipment (UE) based on the transmission of the first SRS, wherein the first C-plane message indicates a first set of channel estimates for a set of active antennas of a plurality of antennas associated with the O-RU, and wherein the first C-plane message does not include channel estimates for a set of inactive antennas of the plurality of antennas.
Aspect 14: The method of aspect 13, wherein the first C-plane message comprises a format indicator to specify that the first C-plane message comprises channel estimate information in a reduced format, and the channel estimate information in the reduced format exclusively indicates the first set of channel estimates for the set of active antennas.
Aspect 15: The method of any of aspects 13 and 14, further comprising: transmitting, to the O-DU, a capability indicator specifying that the O-RU supports the channel estimate information in the reduced format.
Aspect 16: The method of any of aspects 13 through 15, wherein in the first C-plane message, each channel estimate of the first set of channel estimates is associated with an antenna identifier of a corresponding active antenna of the set of active antennas.
Aspect 17: The method of aspect 16, further comprising: transmitting a second SRS associated with the UE; and receiving a second C-plane message that indicates one or more channel estimates for one or more active antennas of the set of active antennas, wherein: the one or more channel estimates deviate from corresponding one or more channel estimates of the first set of channel estimates, and the second C-plane message does not include at least one channel estimate of at least one active antenna of the set of active antennas.
Aspect 18: The method of any of aspects 13 through 15, further comprising: receiving, from the O-DU, a third C-plane message associated with the plurality of antennas prior to the reception of the first C-plane message, wherein the third C-plane message indicates the set of active antennas and the set of inactive antennas.
Aspect 19: The method of aspect 18, wherein in the first C-plane message, the first set of channel estimates for the set of active antennas is indicated in a same sequence in which the set of active antennas is indicated in the third C-plane message.
Aspect 20: The method of any of aspects 13 through 19, wherein the set of active antennas corresponds to one or more first antennas among the plurality of antennas that are switched ON, and the set of inactive antennas corresponds to one or more second antennas among the plurality of antennas that are switched OFF.
Aspect 21: The method of any of aspects 13 through 16 or any of aspects 18 through 20, further comprising: determining a set of beamforming weights for the set of active antennas based on the first C-plane message; controlling the plurality of antennas based on the third C-plane message and the set of beamforming weights; and communicating with the UE based on the control of the plurality of antennas.
Aspect 22: An apparatus for wireless communication in an Open-Radio Access Network (O-RAN) Distributed Unit (O-DU), comprising: one or more processors; one or more memories coupled with the one or more processors; and instructions stored in the one or more memories and executable by the one or more processors to cause the apparatus to perform a method of any of aspects 1 through 12.
Aspect 23: A non-transitory computer-readable medium storing code for wireless communication, in an Open-Radio Access Network (O-RAN) Distributed Unit (O-DU), the code comprising instructions executable by one or more processors to perform a method of any of aspects 1 through 12.
Aspect 24: An apparatus for wireless communication in an Open-Radio Access Network (O-RAN) Radio Unit (O-RU), comprising: one or more processors; one or more memories coupled with the one or more processors; and instructions stored in the one or more memories and executable by the one or more processors to cause the apparatus to perform a method of any of aspects 13 through 21.
Aspect 25: An apparatus for wireless communication in an Open-Radio Access Network (O-RAN) Radio Unit (O-RU), comprising at least one means for performing a method of any of aspects 13 through 21.
Aspect 26: A non-transitory computer-readable medium storing code for wireless communication in an Open-Radio Access Network (O-RAN) Radio Unit (O-RU), the code comprising instructions executable by one or more processors to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

As used herein, the phrase ‘one or more processors are configured to’ may encompass various implementations, including but not limited to: (A) processors that are programmed and capable of performing the function, regardless of whether execution is occurring at a given time; (B) processors actively executing instructions to perform the function; and (C) processors that, when triggered by an event or condition, initiate execution of the function. This interpretation is not intended to limit the scope of the claims to only an actively functioning device.

Unless explicitly stated otherwise, the recitation of “one or more processors configured to” is not intended to require that all operations be performed by the same individual processor. Rather, the described functionality may be distributed among multiple processors operating individually or collectively, including configurations in which different processors are configured to perform different subsets of the operations. Such distribution may be static or dynamic and concurrent or sequential.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. An Open-Radio Access Network (O-RAN) Distributed Unit (O-DU) for wireless communication, the O-DU comprising:
one or more memories; and
one or more processors coupled to the one or more memories, wherein the one or more processors are individually or collectively configured to cause the O-DU to:
receive a first sounding reference signal (SRS) associated with a user equipment (UE);
generate, based on the first SRS, a first control plane (C-plane) message that indicates a first set of channel estimates for a set of active antennas of a plurality of antennas associated with an O-RAN Radio Unit (O-RU), wherein:
the first C-plane message does not include channel estimates for a set of inactive antennas of the plurality of antennas; and
transmit the first C-plane message to the O-RU.

2. The O-DU of claim 1, wherein:
the first C-plane message comprises a format indicator to specify that the first C-plane message comprises channel estimate information in a reduced format, and
the channel estimate information in the reduced format exclusively indicates the first set of channel estimates for the set of active antennas.

3. The O-DU of claim 2, wherein:
the one or more processors are individually or collectively further configured to cause the O-DU to:
receive, from the O-RU, a capability indicator specifying that the O-RU supports the channel estimate information in the reduced format.

4. The O-DU of claim 3, wherein:
the reception of the capability indicator is via a management plane (M-plane) message, and
the capability indicator is received prior to the reception of the first SRS.

5. The O-DU of claim 1, wherein:
in the first C-plane message, each channel estimate of the first set of channel estimates is associated with an antenna identifier of a corresponding active antenna of the set of active antennas.

6. The O-DU of claim 5, wherein:
the one or more processors are individually or collectively further configured to cause the O-DU to:
receive a second SRS associated with the UE after the reception of the first SRS;
determine a second set of channel estimates for the set of active antennas based on the second SRS;
generate a second C-plane message that indicates one or more channel estimates of the determined second set of channel estimates, wherein:
the one or more channel estimates of the determined second set of channel estimates deviate from corresponding one or more channel estimates of the first set of channel estimates, and
the second C-plane message does not include at least one channel estimate of the second set of channel estimates that is same as a corresponding channel estimate of the first set of channel estimates; and
transmit the second C-plane message to the O-RU.

7. The O-DU of claim 1, wherein:
the first C-plane message corresponds to a Section Type 6 (ST6) message.

8. The O-DU of claim 1, wherein:
the set of active antennas corresponds to one or more first antennas among the plurality of antennas that are switched ON, and
the set of inactive antennas corresponds to one or more second antennas among the plurality of antennas that are switched OFF.

9. The O-DU of claim 1, wherein:
the one or more processors are individually or collectively further configured to cause the O-DU to:
transmit, to the O-RU, a third C-plane message associated with the plurality of antennas prior to the transmission of the first C-plane message, wherein:
the third C-plane message indicates the set of active antennas and the set of inactive antennas.

10. The O-DU of claim 9, wherein:
the third C-plane message comprises a bitmap having a plurality of bits,
each bit of the plurality of bits is mapped to a corresponding antenna of the plurality of antennas, and
each bit of the plurality of bits has one of a first value indicating that the corresponding antenna is active, or a second value indicating that the corresponding antenna is inactive.

11. The O-DU of claim 10, wherein:
in the first C-plane message, the first set of channel estimates for the set of active antennas is indicated in a same sequence in which the set of active antennas is indicated in the bitmap of the third C-plane message.

12. The O-DU of claim 1, wherein:
each channel estimate of the first set of channel estimates is associated with a plurality of physical resource blocks associated with the UE.

13. An Open-Radio Access Network (O-RAN) Radio Unit (O-RU) for wireless communication, the O-RU comprising:
one or more memories; and
one or more processors coupled to the one or more memories, wherein:
the one or more processors are individually or collectively configured to cause the O-RU to:
transmit, to an O-RAN Distributed Unit (O-DU), a first sounding reference signal associated with a user equipment (UE); and
receive, from the O-DU, a first control plane (C-plane) message in response to the transmission of the first SRS, wherein:
the first C-plane message indicates a first set of channel estimates for a set of active antennas of a plurality of antennas associated with the O-RU, and
the first C-plane message does not include channel estimates for a set of inactive antennas of the plurality of antennas.

14. The O-RU of claim 13, wherein:
the first C-plane message comprises a format indicator to specify that the first C-plane message comprises channel estimate information in a reduced format, and
the channel estimate information in the reduced format exclusively indicates the first set of channel estimates for the set of active antennas.

15. The O-RU of claim 14, wherein:
the one or more processors are individually or collectively further configured to cause the O-RU to:
transmit, to the O-DU, a capability indicator specifying that the O-RU supports the channel estimate information in the reduced format.

16. The O-RU of claim 13, wherein:
in the first C-plane message, each channel estimate of the first set of channel estimates is associated with an antenna identifier of a corresponding active antenna of the set of active antennas.

17. The O-RU of claim 16, wherein:
the one or more processors are individually or collectively further configured to cause the O-RU to:
transmit a second SRS associated with the UE; and
receive a second C-plane message that indicates one or more channel estimates for one or more active antennas of the set of active antennas, wherein:
the one or more channel estimates deviate from corresponding one or more channel estimates of the first set of channel estimates, and
the second C-plane message does not include at least one channel estimate of at least one active antenna of the set of active antennas.

18. The O-RU of claim 13, wherein:
the one or more processors are individually or collectively further configured to cause the O-RU to:
receive, from the O-DU, a third C-plane message associated with the plurality of antennas prior to the reception of the first C-plane message, wherein:
the third C-plane message indicates the set of active antennas and the set of inactive antennas,
the set of active antennas corresponds to one or more first antennas among the plurality of antennas that are switched ON,
the set of inactive antennas corresponds to one or more second antennas among the plurality of antennas that are switched OFF, and
in the first C-plane message, the first set of channel estimates for the set of active antennas is indicated in a same sequence in which the set of active antennas is indicated in the third C-plane message.

19. The O-RU of claim 18, wherein:
the one or more processors are individually or collectively further configured to cause the O-RU to:
determine a set of beamforming weights for the set of active antennas based on the first C-plane message;
control the plurality of antennas based on the third C-plane message and the set of beamforming weights; and
communicate with the UE based on the control of the plurality of antennas.

20. A wireless communication method in an Open-Radio Access Network (O-RAN) Distributed Unit (O-DU), comprising:
receiving a first sounding reference signal (SRS) associated with a user equipment (UE);
generating, based on the first SRS, a first control plane (C-plane) message that indicates a first set of channel estimates for a set of active antennas of a plurality of antennas associated with an O-RAN Radio Unit (O-RU), wherein:
the first C-plane message does not include channel estimates for a set of inactive antennas of the plurality of antennas; and
transmitting the first C-plane message to the O-RU.
